(19) United States
(12) Patent Application Publication
(10) Pub. No.: US 2022/0397911 A1
(43) Pub. Date: Dec. 15, 2022

(54) TRANSPORT DEVICE, CONTROL METHOD, AND RECORDING MEDIUM ON WHICH CONTROL PROGRAM IS RECORDED

(71) Applicant: NEC Corporation, Minato-ku, Tokyo (JP)

(72) Inventors: Kumiko TADANO, Tokyo (JP); Tsutomu OSODA, Kanagawa (JP); Yoshiharu MAENO, Tokyo (JP)

(73) Assignee: NEC Corporation, Minato-ku, Tokyo (JP)

(21) Appl. No.: 17/777,160

(22) PCT Filed: Nov. 18, 2019
(86) PCT No.: PCT/JP2019/045119

§ 371 Date: May 16, 2022

(51) Int. Cl. G05D 1/02; B65G 21/12; B65G 43/00

(52) U.S. Cl. CPC G05D 1/0293; B65G 21/12; B65G 43/00

(57) ABSTRACT

A transport device according to the present invention includes: a transport unit that transports a transport object; a moving unit that controls movement of the transport device; and a control unit that controls an operation of the transport unit and the moving unit according to an instruction. In a case that the instruction includes forming group transport, the control unit controls the moving unit to move to a position where a group for implementing the group transport is formed, and controls the transport unit to transport the transport object at the position. In a case that the instruction includes implementing individual transport, the control unit controls the moving unit to move from the transport source to the transport destination.

This application is a National Stage Entry of PCT/JP2019/045119 filed on Nov. 18, 2019, the contents of all of which are incorporated herein by reference, in their entirety.

### TECHNICAL FIELD

The present invention relates to a transport device that performs transport work, and the like.

### BACKGROUND ART

In a system such as a factory or a warehouse, transport work of transporting a wide variety of transport objects from a loading source to a loading destination is performed. The transport object is, for example, an electronic component, a chemical agent, a product in process, a component, a by-product, a raw material, a pallet, a product, a commodity, or the like. The loading source and the loading destination represent workstations, cells, or the like.

For the transport work, for example, a conveyor installed between a transport source and a transport destination, an automated guided vehicle (AGV) that conveys the transport object from the transport source to the transport destination, or the like is used. PTLs 1 to 3 disclose a conveyor capable of transporting a transport object in various directions along a certain transport surface. PTL 4 discloses an example of a transport vehicle that transports a transport object to a transport destination.

Meanwhile, products produced in a factory or commodities managed in a warehouse are frequently changed by a demand change in a shorter cycle such as a season factor, a climate factor, a promotion, or a temporary trend. In accordance with these changes, the transport source, the transport destination, the transport direction, the transport amount, the type of the transport object, and the like also change. That is, a transport mode of transporting the transport object also changes according to the change in products or commodities. PTL 5 discloses an operation of knitting a conveyor while connecting a plurality of carts in series and transporting a transport object using the conveyor, and an operation of transporting the transport object by an individual cart.

### CITATION LIST

### Patent Literature

[PTL 1] WO 2014/012861 A
[PTL 2] EP 2874923 B
[PTL 3] WO 2018/038171 A
[PTL 4] JP 2011-216007 A
[PTL 5] JP 2008-501592 A

### SUMMARY OF INVENTION

### Technical Problem

However, even if the devices disclosed in PTLs 1 to 5 are used, for example, in a case where the transport amount, the transport mode, or the like in the system changes, it is not always possible to implement the transport mode with high transport efficiency. This is because even if the devices disclosed in PTLs 1 to 4 are used, it is not always possible to cope with the change in the transport amount, and furthermore, even if the device disclosed in PTL 5 is used, it is not always possible to flexibly cope with the change in the transport mode in the system.

Therefore, one of objects of the present invention is to provide a transport device and the like capable of achieving high transport efficiency.

### Solution to Problem

As one aspect of the present invention, a transport device includes:

a transport unit that transports a transport object;

a moving unit that controls movement of the transport device; and

a control unit that controls an operation of the transport unit and the moving unit according to an instruction, in which

in a case that the instruction includes forming a situation of implementation of group transport in which a plurality of transport devices performs transport in cooperation from a transport source to a transport destination, the control unit controls the moving unit to move to a position where a group for implementing the group transport is formed, and controls the transport unit to transport the transport object at the position, and

in a case that the instruction includes implementing individual transport of conveying the transport object from the transport source to the transport destination, the control unit controls the moving unit to move from the transport source to the transport destination.

As another aspect of the present invention, a transport method includes:

by a transport device including a transport unit that transports a transport object and a moving unit that controls movement of the transport device, and the transport device that controls an operation of the transport unit and the moving unit according to an instruction,

in a case of the instruction instructing formation of group transport in which a plurality of the transport devices performs transport in cooperation from a transport source to a transport destination, controlling the moving unit to move to a position where a group for implementing the group transport is formed, and controlling the transport unit to transport the transport object at the position; and

in a case of the instruction instructing implementation of individual transport of conveying the transport object from the transport source to the transport destination, controlling the moving unit to move from the transport source to the transport destination.

As another mode of the present invention, a control program causes a transport device including a transport unit that transports a transport object and a moving unit that controls movement of the transport device, the transport device that controls the transport unit and the moving unit according to an instruction, to perform a method. The method includes:

in a case that the instruction includes forming a situation of the instruction instructing implementation of group transport in which a plurality of the transport devices performs transport in cooperation from a transport source to a transport destination, controlling the moving unit to move to a position where a group for implementing the group transport is formed, and controlling the transport unit to transport the transport object at the position; and

in a case that the instruction includes implementing individual transport of conveying the transport object from the transport source to the transport destination, controlling the moving unit to move from the transport source to the transport destination.

Moreover, the above object is also implemented by a computer-readable recording medium that embodies the program.

### Advantageous Effects of Invention

According to the transport device and the like of the present invention, high transport efficiency can be achieved.

### BRIEF DESCRIPTION OF DRAWINGS

FIG. 1 is a block diagram illustrating an example of a configuration of a target system according to a first example embodiment of the present invention.

FIG. 2 is a block diagram illustrating an example of a configuration of a transport device according to the first example embodiment.

FIG. 3 is a diagram conceptually illustrating group transport and individual transport performed in the target system.

FIG. 4 is a flowchart illustrating first half of processing in the transport control device.

FIG. 5 is a flowchart illustrating second half of processing in the transport control device.

FIG. 6 is a flowchart illustrating an example of a flow of operation in the transport device in the case of group transport.

FIG. 7 is a flowchart illustrating an example of a flow of operation in the transport device in the case of individual transport.

FIG. 8 is a diagram conceptually illustrating an example of request information.

FIG. 9 is a diagram conceptually illustrating an example of movement information.

FIG. 10 is a diagram conceptually illustrating an example of layout information.

FIG. 11 is a diagram conceptually illustrating obstacles in the target system.

FIG. 12 is a diagram conceptually illustrating transport path information stored in a transport path information storage unit.

FIG. 13A is a view illustrating a first example of a configuration in which a moving unit and a transport unit are independent of each other.

FIG. 13B is a view illustrating a second example of a configuration in which a moving unit and a transport unit are independent of each other.

FIG. 13C is a view illustrating a third example of a configuration in which a moving unit and a transport unit are independent of each other.

FIG. 13D is a view illustrating a fourth example of a configuration in which a moving unit and a transport unit are independent of each other.

FIG. 13E is a view illustrating a fifth example of a configuration in which a moving unit and a transport unit are independent of each other.

FIG. 13F is a view illustrating a sixth example of a configuration in which a moving unit and a transport unit are independent of each other.

FIG. 14A is a view conceptually illustrating an example of individual transport.

FIG. 14B is a view conceptually illustrating an example of group transport.

FIG. 15A is a view conceptually illustrating a first state in an example of an operation flow for controlling the transport devices by group transport.

FIG. 15B is a view conceptually illustrating a second state in the example of the operation flow for controlling the transport devices by group transport.

FIG. 15C is a view conceptually illustrating a third state in the example of the operation flow for controlling the transport devices by group transport.

FIG. 16A is a view conceptually illustrating a first state in an example of an operation flow for controlling the transport devices while forming a transport path in group transport.

FIG. 16B is a view conceptually illustrating a second state in the example of the operation flow for controlling the transport devices while forming a transport path in group transport.

FIG. 16C is a view conceptually illustrating a third state in the example of the operation flow for controlling the transport devices while forming a transport path in group transport.

FIG. 17 is a view conceptually illustrating an example of an operation flow for controlling the transport devices.

FIG. 18A is a view conceptually illustrating a first state in an example of an operation flow for controlling the transport devices to configure a transport path different from FIGS. 15A to 15C in group transport.

FIG. 18B is a view conceptually illustrating a second state in the example of the operation flow for controlling the transport devices to configure a transport path different from FIGS. 15A to 15C in group transport.

FIG. 18C is a view conceptually illustrating a third state in the example of the operation flow for controlling the transport devices to configure a transport path different from FIGS. 15A to 15C in group transport.

FIG. 18D is a view conceptually illustrating a fourth state in the example of the operation flow for controlling the transport devices to configure a transport path different from FIGS. 15A to 15C in group transport.

FIG. 19 is a diagram conceptually illustrating time-series transition of a transport request amount.

FIG. 20 is a diagram conceptually illustrating a change in a transport mode in a case where the number of transport devices is fixed.

FIG. 21 illustrates an example of an operation of changing allocation between group transport and individual transport.

FIG. 22 illustrates an example of an operation of changing allocation between group transport and individual transport in a case where the number of transport devices is variable.

FIG. 23 is a diagram conceptually illustrating an example of a coupling mode among a plurality of transport devices.

FIG. 24A is a perspective view illustrating a first configuration example of the transport device.

FIG. 24B is a perspective view illustrating a second configuration example of the transport device.

FIG. 24C is a perspective view illustrating a third configuration example of the transport device.

FIG. 24D is a perspective view illustrating a fourth configuration example of the transport device.

FIG. 24E is a perspective view illustrating a fifth configuration example of the transport device.

FIG. 24F is a perspective view illustrating a sixth configuration example of the transport device.

FIG. 25A is a perspective view illustrating a first configuration example of a transport device having a mechanism that prevents an operation of a moving unit from being transmitted to the outside.

FIG. 25B is a perspective view illustrating a second configuration example of the transport device having a mechanism that prevents an operation of a moving unit from being transmitted to the outside.

FIG. 25C is a perspective view illustrating a third configuration example of the transport device having a mechanism that prevents an operation of a moving unit from being transmitted to the outside.

FIG. 25D is a perspective view illustrating a fourth configuration example of the transport device having a mechanism that prevents an operation of a moving unit from being transmitted to the outside.

FIG. 25E is a perspective view illustrating a fifth configuration example of the transport device having a mechanism that prevents an operation of a moving unit from being transmitted to the outside.

FIG. 25F is a perspective view illustrating a sixth configuration example of the transport device having a mechanism that prevents an operation of a moving unit from being transmitted to the outside.

FIG. 25G is a perspective view illustrating a seventh configuration example of the transport device having a mechanism that prevents an operation of a moving unit from being transmitted to the outside.

FIG. 26 is a diagram conceptually illustrating an example in which a plurality of transport devices forms a group.

FIG. 27 is a block diagram illustrating an example of a configuration of a transport control device according to a second example embodiment of the present invention.

FIG. 28 is a flowchart illustrating an example of a flow of processing of the transport control device according to the second example embodiment.

FIG. 29 is a perspective view illustrating an example of a configuration of a transport device according to a third example embodiment of the present invention.

FIG. 30 is a flowchart illustrating an example of a flow of an operation of the transport device according to the third example embodiment.

FIG. 31 is a block diagram schematically illustrating a hardware configuration example of a calculation processing device capable of implementing a transport device or a transport control device according to one of the example embodiments of the present invention.

### EXAMPLE EMBODIMENT

Example embodiments implementing the present invention will be described in detail with reference to the drawings.

### First Example Embodiment

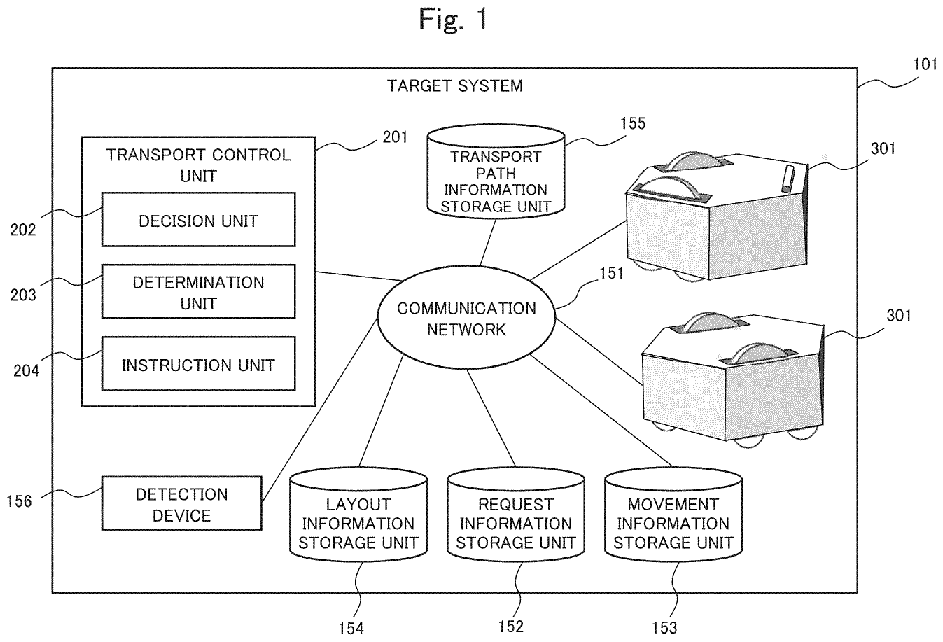

A configuration of a target system 101 according to a first example embodiment of the present invention will be described in detail with reference to FIG. 1. FIG. 1 is a block diagram illustrating an example of a configuration of the target system 101 according to the first example embodiment of the present invention.

The target system 101 includes a transport control device 201, a transport device 301, a communication network 151, and a detection device 156. The target system 101 may include a request information storage unit 152, a movement information storage unit 153, a layout information storage unit 154, and a transport path information storage unit 155.

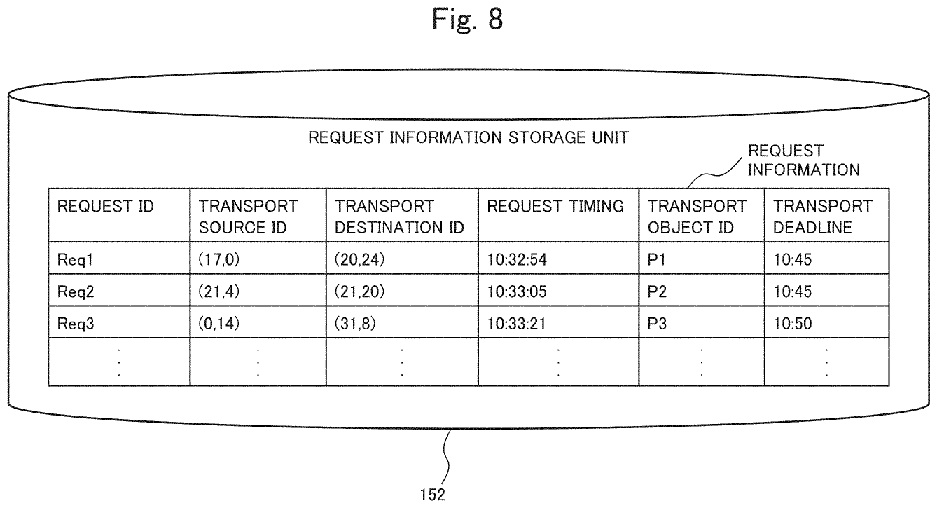

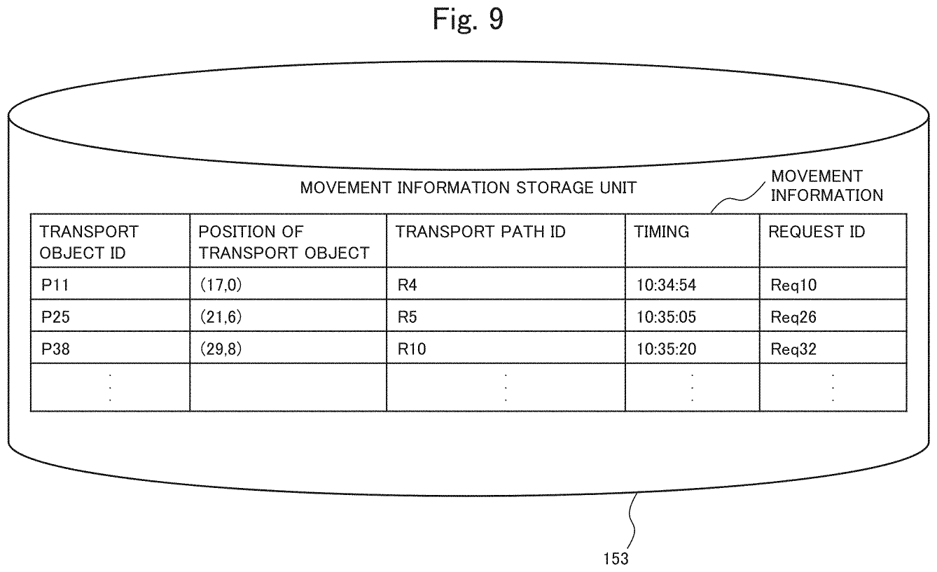

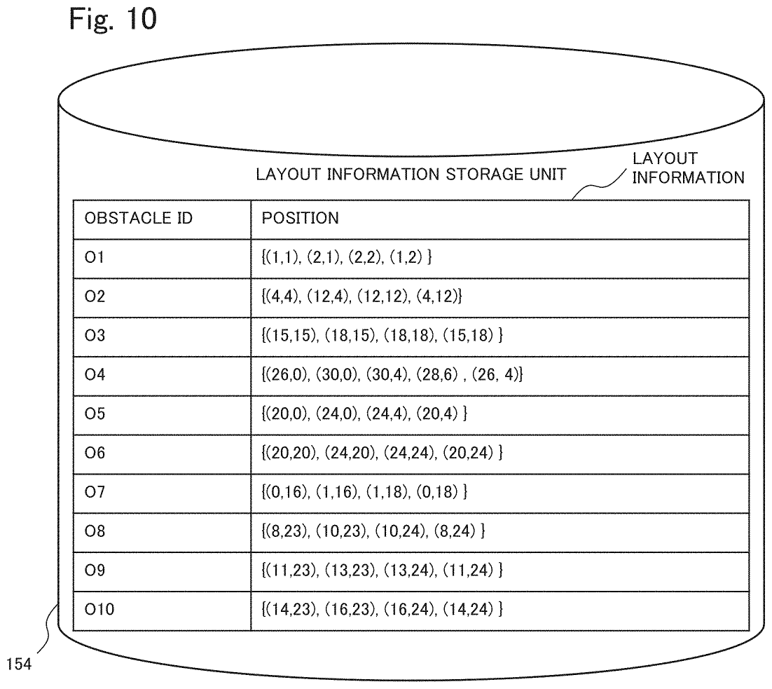

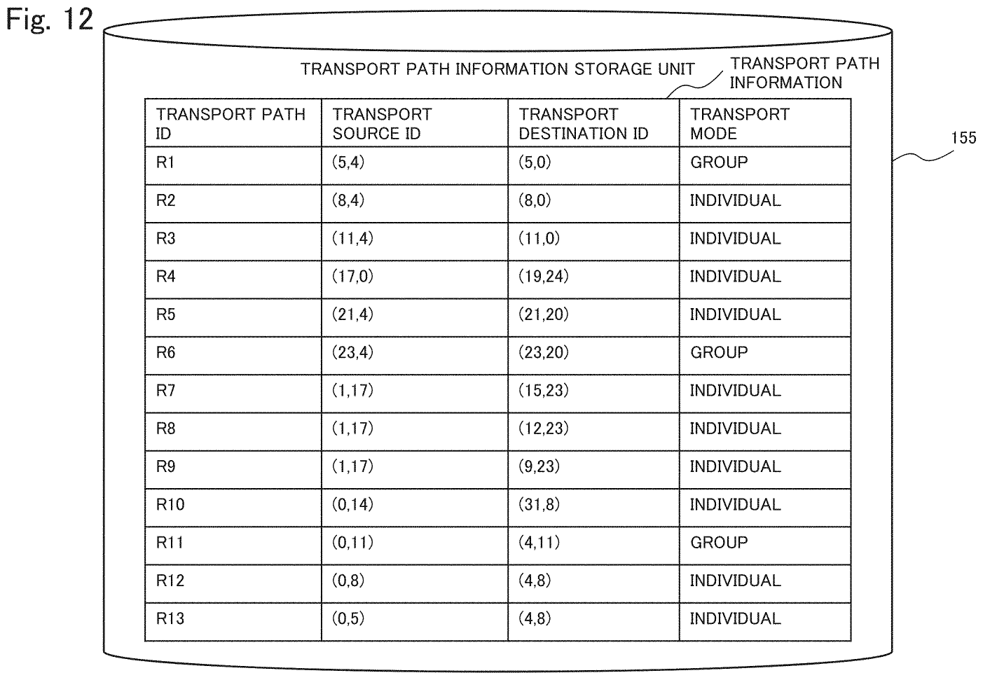

The request information storage unit 152 will be described below with reference to FIG. 8. The movement information storage unit 153 will be described below with reference to FIG. 9. The layout information storage unit 154 will be described below with reference to FIG. 10. The transport path information storage unit 155 will be described below with reference to FIG. 12.

The transport control device 201, the transport device 301, the request information storage unit 152, the movement information storage unit 153, the layout information storage unit 154, the transport path information storage unit 155, and the detection device 156 are communicably connected via the communication network 151.

The transport control device 201 includes a decision unit 202, a determination unit 203, and an instruction unit 204.

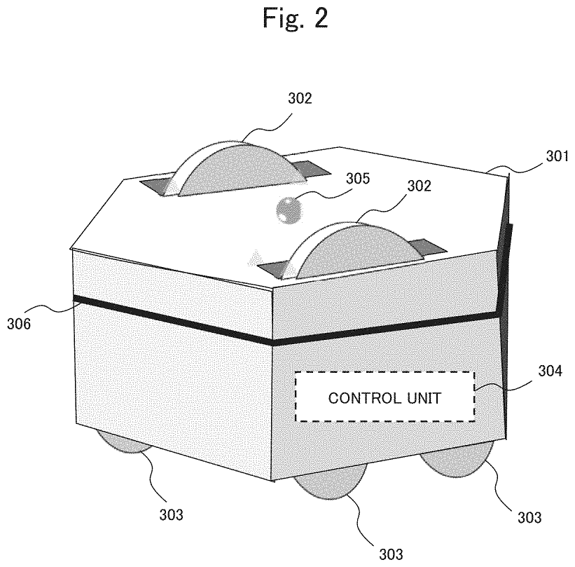

A configuration of the transport device 301 according to the first example embodiment of the present invention will be described in detail with reference to FIG. 2. FIG. 2 is a block diagram illustrating an example of a configuration of the transport device 301 according to the first example embodiment of the present invention.

The transport device 301 includes a transport unit 302, a moving unit 303, and a control unit 304. The transport device 301 may include a detection unit 305 and a rotating unit 306.

The moving unit 303 enables movement of the transport device 301. The moving unit 303 can be implemented using, for example, wheels, an endless track (for example, crawlers), an air cushion, a propeller, or the like. The moving unit 303 moves the transport device 301 such that the transport device 301 approaches a target position. Alternatively, the moving unit 303 moves the transport device 301 such that the transport device 301 approaches a target state (for example, orientation). The moving unit 303 can adjust an operation speed of the wheels, crawlers, or the like. The moving unit 303 can use power such as air pressure, hydraulic pressure, or electricity as an actuator of the moving unit 303. The moving unit 303 has an effect of reducing safety concerns in an overload state by using the air pressure as the power. The moving unit 303 has an effect of obtaining large power by using the hydraulic pressure as the power. The moving unit 303 has an effect of easily performing control by using the electricity as the power.

The moving unit 303 is installed in a lower portion of the transport device 301. The moving unit 303 may be installed on a side surface of the transport device 301.

In the following description, for convenience of description, the moving unit 303 is assumed to be installed in a lower portion of the transport device 301.

The detection unit 305 detects positions of other transport devices 301 and states of other transport devices 301 (for example, orientations), a position of a transport object, a state of the transport object, movement of the transport object, and the like by a sensor, a camera, or the like. The detection unit 305 is installed on, for example, an upper portion of the transport device 301. As illustrated in FIG. 2, the detection unit 305 is installed at a position not in contact with the transport object, such as a center of a plurality of wheels or a center of a plurality of infinite tracks. The detection unit 305 is not necessarily installed in the transport device 301, and may be installed to detect the transport devices 301, the transport object, and the like from the outside.

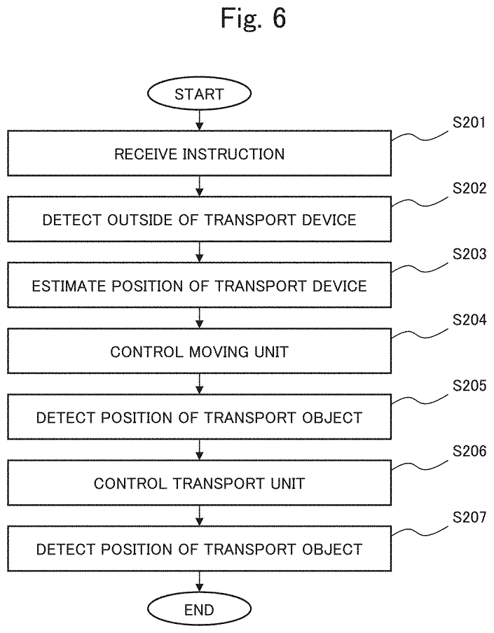

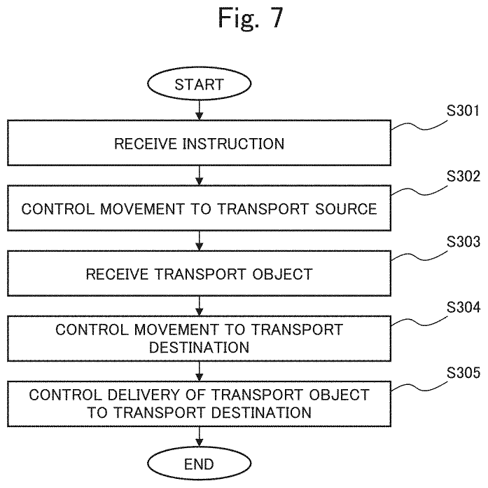

The control unit 304 controls the transport unit 302 and the moving unit 303 as will be described below with reference to FIGS. 6 and 7 on the basis of information obtained by the detection unit 305. For example, the control unit 304 controls the transport unit 302 on the basis of the movement of the transport object detected by the detection unit 305. The control unit 304 controls the moving unit 303 on the basis of, for example, information indicating surroundings of the transport device 301 detected by the detection unit 305.

The rotating unit 306 adjusts a transportable direction by the transport unit 302.

The transport unit 302 transports the transport object. The transport unit 302 can transport the transport object in a direction in which the transport object approaches the transport destination. The transportable direction may be one direction or a plurality of directions. The transport unit 302 can be implemented using, for example, a belt, a tire, a flapper, air injection, a wheel, a belt conveyor, a chain conveyor, a driving roller, or the like.

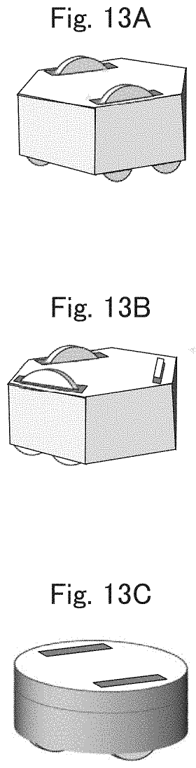

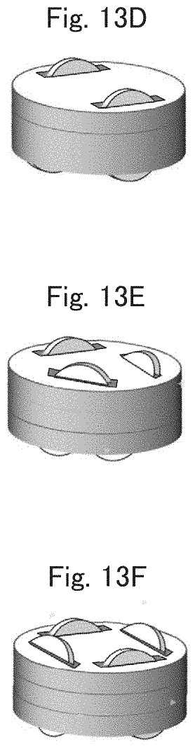

As illustrated in FIGS. 13A to 13F, the moving unit 303 and the transport unit 302 may have configurations independent of each other. FIGS. 13A to 13F are views illustrating examples (first example to sixth example) of configurations of the moving unit 303 and the transport unit 302 that are independent of each other. In FIGS. 13A to 13F, the moving unit 303 is installed in the lower portion of the transport device 301. The transport unit 302 is installed on the upper portion of the transport device 301.

The moving unit 303 and the transport unit 302 may be controlled by a common unit. The moving unit 303 and the transport unit 302 may be controlled by power from one motor, for example. Even in a case where the direction in which the transport unit 302 can transport the transport object is limited like a belt conveyor, the moving unit 303 can transport the transport object in various directions by changing the direction of the transport device 301.

In the transport device 301, the detection unit 305 may detect that the transport object approaches the transport device 301 or the transport object moves away from the transport device 301 using a sensor. The sensor is, for example, at least one sensor of an infrared sensor, an image sensor, a contact sensor, or an ultrasonic sensor. The detection unit 305 may detect the state of another transport device, the state of the transport device of the detection unit 305, and a relationship (for example, a relative position, a relative angle, or the like) between the transport device of the detection unit 305 and the another transport device, using the sensor.

The moving unit 303, the transport unit 302, and the detection unit 305 are not limited to the above-described examples.

For example, the transport control device 201 receives at least one of request information (illustrated in FIG. 8), movement information (illustrated in FIG. 9), layout information (illustrated in FIG. 10), and transport path information (illustrated in FIG. 12).

The request information (illustrated in FIG. 8) is information indicating necessity of transport of the transport object from the transport source to the transport destination. As illustrated in FIG. 8, the request information is, for example, information associated with the following information:
a transport source identifier (hereinafter, “ID (identifier)”) capable of identifying the transport source;
a transport destination ID representing the transport destination;
a transport object ID capable of identifying the content of the transport object;
timing of issuing the transport request; and
a transport deadline for transporting the transport object to the transport destination.

FIG. 8 is a diagram conceptually illustrating an example of the request information stored in the request information storage unit 152. The request information may be information further associated with the shape of the transport object, the size of the transport object, the amount of the transport object, or the like.

For example, the request information includes a request in which a request ID “Req1”, a transport source ID “(17, 0)”, a transport destination ID “(20, 24)”, request timing “10:32:54”, a transport object ID “P1”, and a transport deadline “10:45” are associated with one another. This represents that the request identified by the request ID “Req1” is a request to transport the transport object identified by the transport object ID “P1” from the transport source identified by the transport source ID “(17, 0)” to the transport destination identified by the transport destination ID “(20, 24)”. The request is a request issued at timing “10:32:54”, and for completing the processing related to the request by the transport deadline “10:45”.

The request information does not necessarily include the above-described information, or may include information different from the above-described information. The request information is not limited to the above-described example.

The movement information (illustrated in FIG. 9) is information indicating a history of transport of the transport object from the transport source to the transport destination. As illustrated in FIG. 9, the movement information is information in which the transport object ID for identifying the transport object, the position of the transport object, a transport path ID for identifying the transport path, timing, and the request ID for identifying the transport request for transport processing are associated with one another. FIG. 9 is a diagram conceptually illustrating an example of the movement information stored in the movement information storage unit 153. The timing represents, for example, timing at which the transport object arrives at the transport destination or current timing.

For example, the movement information includes movement information in which the transport object ID “P25”, the position “(21, 6)” of the transport object, the transport path ID “R5”, the timing “10:35:05”, and the request ID “Req26” are associated with one another. This represents a history of moving the transport object identified by the transport object ID “P25” via the path identified by the transport path ID “R5” in accordance with the request identified by the request ID “Req26”. This further represents that the transport processing in response to the request is completed at the timing “10:35:05”, and the transport object is located at the position “(21, 6)”.

Alternatively, this represents moving the transport object identified by the transport object ID “P25” via the path identified by the transport path ID “R5” in accordance with the request identified by the request ID “Req26”. This represents that the transport object is located at the position “(21, 6)” at the timing “10:35:05”. In other words, in the movement information, the position may be information indicating the position of the transport object at predetermined timing. In this case, the timing represents timing at which the transport object moves to the position. For example, the position of the transport object can be specified using, for example, a radio frequency identifier (RFID).

The movement information does not necessarily include the above-described information, or may include information different from the above-described information. The movement information is not limited to the above-described example.

The layout information (illustrated in FIG. 10) is information indicating a state of a space including the transport object and the transport device 301. The layout information is, for example, information such as a state (a position, a size, or the like) of a rack placed on a building, a shape of the building, or a state (position, size, or the like) of a processing machine. In other words, the layout information is information that is a basis for determining the transport mode in the target system 101. The layout information can also be said to be, for example, information indicating a region where the transport device 301 cannot be located, of the target system 101. The layout information may be said to be, for example, information indicating a region where the transport device 301 can be located, of the target system 101.

The layout information may be information by which the position of an obstacle as illustrated in FIG. 10 is specifiable. FIG. 10 is a diagram conceptually illustrating an example of the layout information stored in the layout information storage unit 154.

In the layout information, an obstacle ID capable of identifying an obstacle is associated with a position representing a feature of the obstacle. For example, in the layout information illustrated in FIG. 10, the obstacle ID “04” is associated with the positions “{(26, 0), (30, 0), (30, 4), (28, 6), and (26, 4)}”. This represents that the shape of the obstacle identified by the obstacle ID “O4” is characterized by {(26, 0), (30, 0), (30, 4), (28, 6), and (26, 4)}. In this case, the obstacle is a pentagon, and respective vertexes of the pentagon are at the positions represented by {(26, 0), (30, 0), (30, 4), (28, 6), and (26, 4)}.

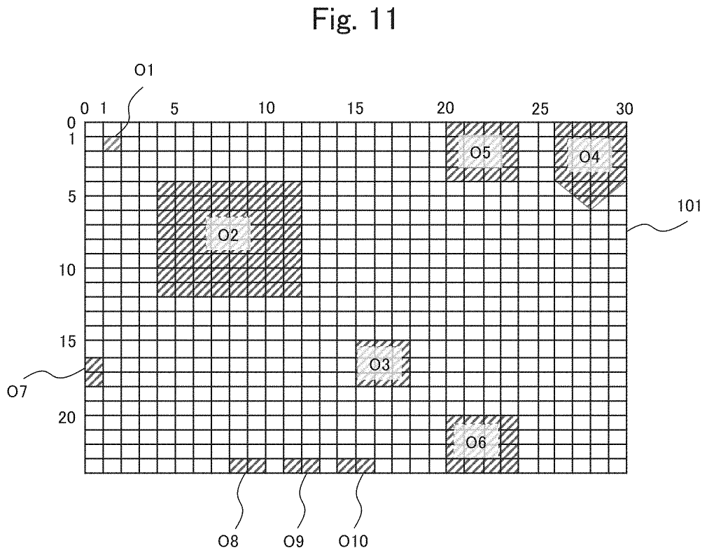

When a map in a certain area is created according to the layout information illustrated in FIG. 10, obstacles are arranged in the layout illustrated in FIG. 11. FIG. 11 is a diagram conceptually illustrating obstacles in the target system 101. In the example illustrated in FIG. 11, the target system 101 is conceptually divided into a lattice shape. A position in the target system 101 is represented using, for example, coordinates of the lattice with an upper left vertex as an origin. The position is represented by a combination of a coordinate value in a horizontal direction in FIG. 11 and a coordinate value in a vertical direction in FIG. 11.

For example, in the layout information illustrated in FIG. 10, the obstacle ID “O1” is associated with the positions “{(1, 1), (2, 1), (2, 2), and (1, 2)}”. In relation to this, in FIG. 11, a rectangle O1 having the four coordinates of (1, 1), (2, 1), (2, 2), and (1, 2) as vertices is hatched. This indicates that there is an obstacle identified by the obstacle ID “O1” at the position. Similarly, for the obstacle ID “O2” to the obstacle ID “O10” in the layout information illustrated in FIG. 10, the positions of the respective obstacles are indicated by hatching in FIG. 11.

The layout information is not limited to the above-described example.

The transport path information will be described with reference to FIG. 12. FIG. 12 is a diagram conceptually illustrating transport path information stored in the transport path information storage unit 155.

The transport path information is information in which the transport path ID, the transport source ID, the transport destination ID, and the transport mode are associated with one another. The transport path information is information indicating whether group transport or individual transport is performed on the transport path from the transport source identified by the transport source ID to the transport destination identified by the transport destination ID.

For example, in the transport path information illustrated in FIG. 12, the transport path ID “R8”, the transport source ID “(1, 17)”, the transport destination ID “(12, 23)”, and the transport mode “individual” are associated with one another. This represents that the transport path identified by the transport path ID “R8” is a transport path between the transport source identified by the transport source ID “(1, 17)” and the transport destination identified by the transport destination ID “(12, 23)”. Further, this represents that the individual transport is being performed or the individual transport has been performed on the transport path.

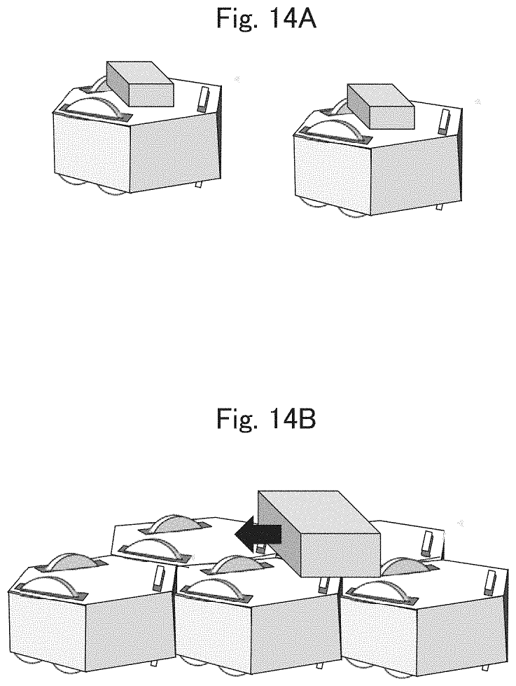

The group transport and the individual transport will be described with reference to FIGS. 14A and 14B. FIG. 14A is a view conceptually illustrating an example of the individual transport. FIG. 14B is a view conceptually illustrating an example of the group transport.

As illustrated in FIG. 14A, the individual transport represents a transport mode in which the transport device 301 moves from the transport source to the transport destination while loading the transport object. For example, the transport object is loaded on the transport device 301. The transport device 301 moves from the transport source to the transport destination in the state of loading the transport object thereon. As a result, the transport device 301 transports the transport object from the transport source to the transport destination.

As illustrated in FIG. 14B, the group transport represents a transport mode in which a plurality of transport devices 301 in a certain region transports the transport object from the transport source to the transport destination in conjunction with one another. In other words, the group transport represents a mode in which the plurality of transport devices 301 forms a conveyor in a group and transports the transport object by the formed conveyor. The transport mode can be implemented by coordinating the transport units 302 included in the transport devices 301. During the group transport, each transport device 301 may stop the moving unit 303.

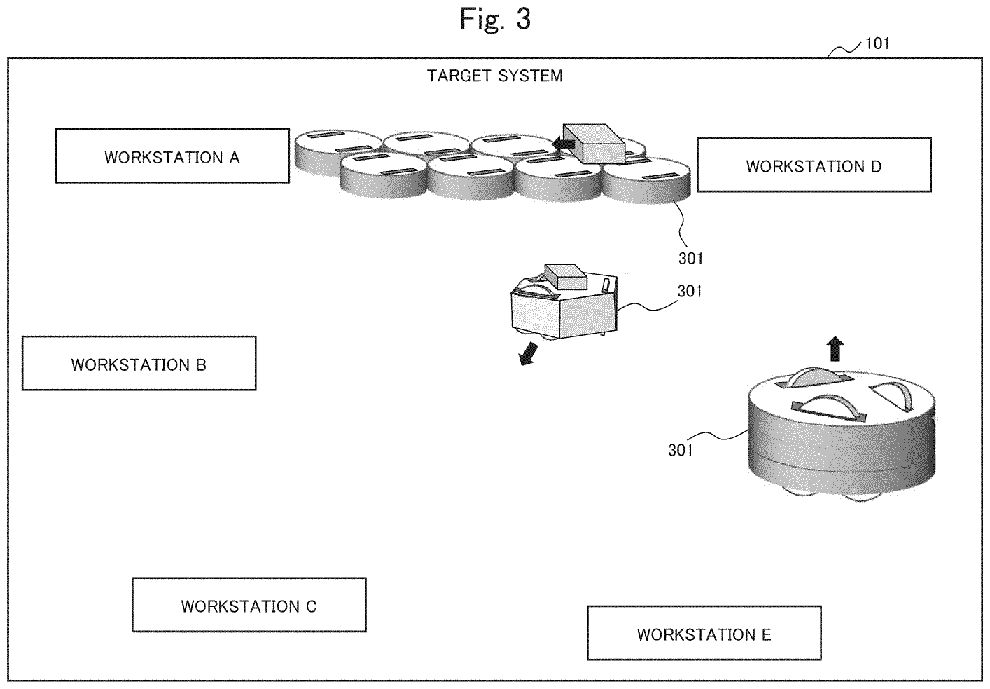

The target system 101 in which the group transport and the individual transport are conducted will be described with reference to FIG. 3. FIG. 3 is a diagram conceptually illustrating the group transport and the individual transport performed in the target system 101.

The target system 101 includes workstations A to E and the transport device 301. Each of the workstations A to E represents, for example, a processing device for creating an intermediate processed product from a raw material, a dyeing device for dyeing a material, or the like. In the target system 101, the workstations A to E perform each processing according to a process procedure of processing a product. When there are many types of products, it may be necessary to change the process procedure.

For example, in FIG. 3, a plurality of transport devices 301 is illustrated between the workstation A and the workstation D. This represents a state in which the plurality of transport devices 301 is conducting the group transport for the transport object from the workstation D to the workstation A. Further, the transport device 301 is illustrated between the workstation C and the workstation D. This represents a state in which the plurality of transport devices 301 is conducting the individual transport for the transport object from the workstation D to the workstation C.

Next, a decision criterion that is a basis for determining assignment will be described.

The decision criterion represents a criterion for determining whether to perform the group transport or the individual transport. The decision criterion may be, for example, a criterion in which the group transport is assigned to the transport request in which the load of the transport processing is high, and the individual transport is assigned to the transport request in which the load is low.

The transport request may be represented using, for example, a pair of the transport source ID and the transport destination ID (hereinafter, a “source and destination (SD) pair”).

The load represents, for example, a request amount for transporting the transport object from the transport source to the transport destination. In this case, the larger the request amount, the higher the load between the transport source and the transport destination, and the smaller the request amount, the lower the load between the transport source and the transport destination. The decision criterion can be said to be a criterion for switching the transport mode according to the load of the transport processing.

The transport device 301 can be effectively used according to the decision criterion.

The decision criterion can also be said to represent, for example, a criterion for deciding whether a plurality of transport devices 301 forms the transport path (illustrated in FIG. 14B, hereinafter, referred to as “group transport”). Alternatively, the decision criterion can also be said to represent, for example, a criterion for deciding whether the transport device 301 moves while loading the transport object (illustrated in FIG. 14A, hereinafter, referred to as “individual transport”).

The group transport can also be said to represent that a plurality of transport devices 301 forms the transport path and transports the transport object on the formed transport path. Alternatively, the group transport can also be said to represent that a plurality of transport devices 301 forms the transport path in cooperation and transports the transport object on the formed transport path. Alternatively, the group transport can also be said to represent that a plurality of transport devices 301 forms a group in cooperation and transports the transport object by the formed group.

The individual transport can be said to represent that the transport device 301 moves from the transport source to the transport destination while loading the transport object.

The load may be, for example, a value at certain timing, a value within a certain period of time (hereinafter expressed as a “time window”), or a value in a variable time window. For example, for each SD pair, the load may be a value such as a maximum value, a mean value, or median value in the time window on the basis of the transport request information of a package or the movement information of the package. The load may be, for example, an index as described below or an index obtained by combining a plurality of indexes as described below:
density or a flow rate of the package between the SD pair;
a delivery time compliance rate of the transport;
a transport completion amount that is an amount of packages that have been transported;
a ratio between the transport completion amount and a transport request amount, that is, a throughput;
an inventory quantity of the transport source;
a difference between the inventory at the transport source and the inventory at the transport destination;
the transport request amount; and
a ratio of time during which the transport device 301 transports a package (operation rate).

The load may be represented using a temporal change in the index as described above or a cumulative value of the indexes within a certain period. The load may be a weighted average of the index values as described above. The load may be any of a maximum value, a mean value, a median value, a differential value, or an integral value within a certain time for the indexes as described above, or may be an index that is a combination of the maximum value and the like.

The load is not limited to the above-described example.

The decision criterion may be, for example, a criterion of ranking the transport requests (for example, SD pairs of the transport source ID and the transport destination ID) in the transport request information in descending order of the load of the transport request, and assigning the group transport to the transport request in the order of the load. The decision criterion may be, for example, a criterion of ranking the transport requests (for example, SD pairs of the transport source ID and the transport destination ID) in the transport request information in descending order of the load of the transport request, and assigning the group transport to the top SD pairs in the ranking. The criterion for deciding whether the ranking is high is, for example, a criterion indicating whether a certain SD pair is included within a ratio of 3%, 5%, 10%, or the like of the total number of SD pairs from the top of the ranking. In this case, the decision criterion can be said to be a criterion based on a threshold value for deciding whether the load is high.

The decision criterion may be expressed using the number of transport devices 301. The decision criterion may be, for example, a criterion of assigning the group transport to the transport request having the highest load, calculating the number of transport devices 301 other than the transport devices 301 assigned to the group transport, and deciding whether there is a sufficient number of transport devices to be assigned to the group transport. In this case, the decision criterion represents a criterion of assigning the group transport to the transport request with the next highest load in the case where the number of transport devices is sufficient for the assignment of the transport devices 301.

The decision criterion may be a criterion of assigning at least one or more transport devices 301 to each transport request. In this case, the decision criterion represents a criterion of assigning the individual transport to the transport request to which the group transport is not assigned. The decision criterion may be a criterion representing that the group transport is performed in the case where the load in the SD pair is a high load, and the individual transport is performed in the case where the load is a low load.

The criterion of determining whether the load is a high load may be, for example, a criterion based on a first threshold value for deciding that the load is a high load. In this case, in the case where the load is the first threshold value or higher, the load is decided to be the high load. Then, in the case where the load is less than the first threshold value, the load is decided not to be the high load.

The criterion of determining whether the load is a low load may be, for example, a criterion based on a second threshold value for deciding that the load is a low load. In this case, in the case where the load is less than the second threshold value, the load is decided to be the low load. Then, in the case where the load is equal to or higher than the second threshold value, the load is decided not to be the low load.

The first threshold value and the second threshold value may be the same value. The first threshold value may be a value larger than the second threshold value.

The decision criterion may be a criterion of assigning the group transport in the case where the load satisfies the criterion and assigning the individual transport in the case where the load does not satisfy the criterion. The criterion represents a condition for deciding whether the load is equal to or larger than a predetermined threshold value.

The decision criterion is not limited to the above-described example.

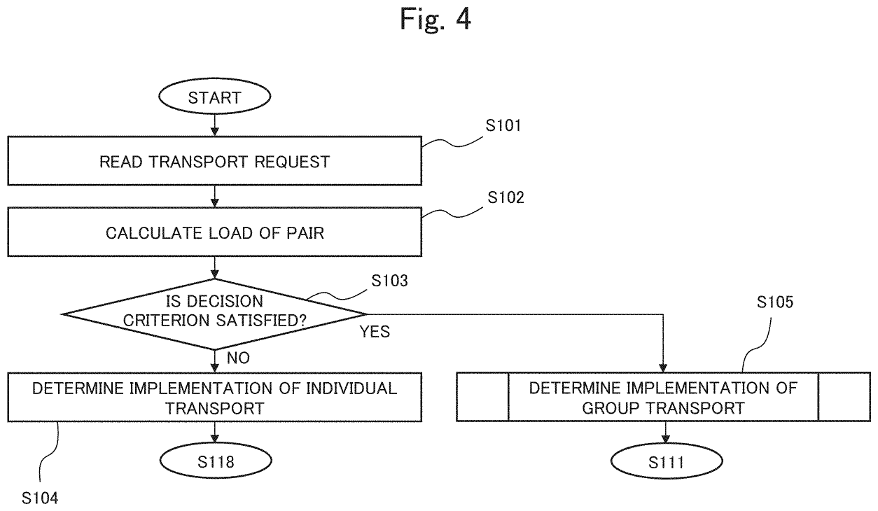

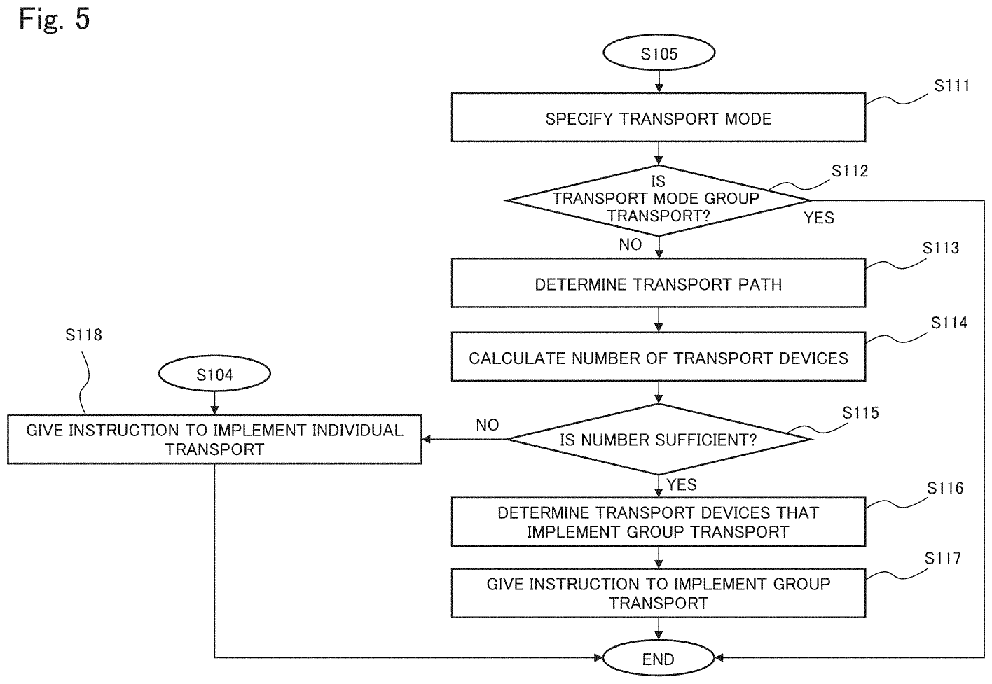

The determination unit 203 receives the request ID for identifying the transport request, the layout information (illustrated in FIG. 10), and the transport mode determined by the processing to be described with reference to FIGS. 4 and 5. The determination unit 203 may receive only the request ID for identifying the transport request for which the decision unit 202 has determined to change the transport mode.

For convenience of description, the determination unit 203 is assumed to receive only the request ID representing the transport request for which the transport mode is to be changed from the individual transport to the group transport, of the transport request. The transport source ID is assumed to represent the position of the transport source. The transport destination ID is assumed to represent the position of the transport destination.

The determination unit 203 determines the transport path in the case of performing the group transport on the basis of the received request ID and layout information. For example, the determination unit 203 reads the transport source ID and the transport destination ID from the transport request information. The determination unit 203 specifies the position of the transport source and the position of the transport destination in the layout information, and calculates the transport path between the specified position of the transport source and the specified position of the transport destination according to a predetermined path calculation procedure.

The predetermined path calculation procedure is, for example, a calculation procedure according to a method such as the Dijkstra method or the A*(A−Star) method. The predetermined path calculation procedure is, for example, a procedure of calculating a path having the transport path that becomes as short as possible. The predetermined path calculation procedure may be, for example, a procedure of calculating a path that minimizes a time required to transport the transport object. The predetermined path calculation procedure may be a procedure of calculating a path that minimizes the number of points where paths on which the transport objects move (that is, traffic lines of the transport objects) intersect (interfere).

The predetermined path calculation procedure is not limited to the above-described example.

The instruction unit 204 receives information of the transport path designed by the determination unit 203. For example, when receiving the information of the transport path for which the transport mode is to be changed from the individual transport to the group transport, the instruction unit 204 instructs the transport devices 301 to form the transport path. In other words, the instruction unit 204 instructs the transport devices 301 to move to a place where the transport devices 301 form the transport path.

The instruction unit 204 may be centrally controlled by a control server, or may be distributedly controlled for each transport device 301.

In the case of centralized control, the instruction unit 204 and the transport device 301 are communicably connected via the communication network 151 such as wireless communication. The instruction unit 204 may instruct the plurality of transport devices 301 to prevent collision in the case where the traffic lines of the plurality of transport devices 301 intersect in the movement processing when forming the transport path. For example, the instruction unit 204 may perform exclusive control so that the plurality of transport devices 301 does not enter one point at certain timing, and instruct the transport devices 301 according to the result. For example, the instruction unit 204 may execute platooning for maintaining an inter-vehicle distance and instruct the transport devices 301 according to the result.

The detection device 156 collects information of the transport object ID for identifying the transport object, the timing, and the position of the transport object at the timing, and stores the collected information in a storage device (not illustrated).

Next, processing in the transport control device 201 according to the first example embodiment will be described with reference to FIGS. 4 and 5. FIGS. 4 and 5 are flowcharts illustrating the processing in the transport control device 201.

Hereinafter, for convenience of description, the processing illustrated in FIGS. 4 and 5 is referred to as “FLOW-A”.

The trigger for starting the processing in FLOW-A may be periodic or may be when an event is detected. The timing at which the event occurs may be predetermined timing.

The timing may be timing at which the throughput of the transport object in the entire target system 101 such as a factory or a warehouse becomes equal to or less than a threshold value. In this case, the threshold value is a value for deciding whether the throughput is low.

The timing may be timing at which the operation rate of the transport device 301 becomes equal to or higher than a threshold value among the plurality of transport devices 301. In this case, the threshold value is a value for deciding whether a variation in the operation rate is large among the plurality of transport devices 301.

The timing may be timing at which the transport device 301 having the operation rate less than the threshold value occurs among the plurality of transport devices 301. In this case, the threshold value is a value for deciding whether the transport device 301 is in an idle state.

The processing in FLOW-A can also be said to be started, as a trigger, when the throughput of the transport object in the target system 101 including a plurality of workstations as the transport destination and the transport source satisfies the criterion for deciding to start the processing. According to the processing, there is an effect of reducing a decrease in the throughput of the transport object in the target system 101.

In the case where the above event occurs while the transport control device 201 is executing FLOW-A, the transport control device 201 may redo FLOW-A from the beginning.

Alternatively, in the case where a sufficient number of transport devices 301 to form the transport path in the group transport cannot be secured, the transport control device 201 may postpone the execution of FLOW-A until the sufficient number of transport devices 301 can be secured. According to the processing, there is an effect of reducing the processing in the transport control device 201.

Alternatively, an operation flow for changing the transport mode may be performed only in the case where a predetermined number or more of the transport devices 301 is operated. In this case, the predetermined number is, for example, the number of transport devices 301 required to form the transport path. According to the processing, there is an effect of reducing the processing in the transport control device 201.

Alternatively, the operation flow for changing the transport mode may not be performed for some of the requests determined to perform the group transport. In this case, the instruction unit 204 does not change the processing of transporting the transport object between the transport source ID and the transport destination ID included in the request to the group transport. For example, in the case of deciding that the cost (time required, moving distance, or the like) required to change the transport mode is higher than a threshold value, the instruction unit 204 performs FLOW-A only for some requests (for example, 5%, 20%, 33% of the total requests). In this case, the threshold value is, for example, a value for deciding that the processing load of the entire target system 101 such as a factory or a warehouse decreases. In the processing of selecting some requests, the instruction unit 204 may randomly select a request from among the requests determined to perform the group transport.

The operation flow for changing the transport mode is not limited to the above-described example.

Each step in FLOW-A will be specifically described with reference to FIGS. 4 and 5.

The decision unit 202 reads the transport request stored in the request information storage unit 152 (illustrated in FIG. 8) (step S101). The decision unit 202 calculates the load between the transport destination identified by the transport destination ID in each request and the transport source identified by the transport source ID in the request (step S102). That is, the decision unit 202 calculates the load of each SD pair. For example, the decision unit 202 sums the transport amount of the transport object identified by the transport object ID for each SD pair of the transport destination ID and the transport source ID. As a result of this processing, the decision unit 202 calculates the load.

The decision unit 202 may calculate the loads for all the SD pairs. The decision unit 202 may calculate loads for some SD pairs. In the case of calculating the loads of some SD pairs, the decision unit 202 may assign the individual transport to the remaining SD pairs.

In the case where the load of the SD pair is calculated in advance, the decision unit 202 may read the load.

The decision unit 202 may select the request having an approaching transport deadline among the transport requests stored in the request information storage unit 152 (illustrated in FIG. 8) and calculate the load of the SD pair on the basis of the selected request. In this case, for example, the decision unit 202 calculates the time from the present to the transport deadline, and selects the request having the time equal to or less than a threshold value. The threshold value is a value for deciding the presence or absence of a possibility of being delayed from the transport deadline. In other words, in the case where the load is a time from the present to the transport deadline, the decision unit 202 may execute the processing according to a criterion that the time is smaller than a value indicating that there is a possibility that arrival at the transport destination will be delayed. According to the processing, there is an effect of reducing the processing of being delayed from the transport deadline.

For example, the decision unit 202 may order the SD pairs in descending order of the calculated load. For convenience of description, the ordered SD pair is denoted as “ranking”.

The decision unit 202 may classify the SD pairs into a plurality of groups according to a group creation procedure, and rank the SD pairs for each of the plurality of groups. In this case, the transport devices 301 are accommodated in a group, for example.

The group creation procedure may be a procedure of classifying the SD pairs for each geographical area. The group creation procedure may be a procedure of classifying the pairs of the transport destination and the transport source into a plurality of groups on the basis of the positions of the workstations in the target system 101 including the plurality of workstations as the transport destination and the transport source. The group creation procedure is used when, for example, a movable area by the transport device 301 is limited. Further, according to the group creation procedure, since the movable area of the transport device 301 is limited, there is an effect that the moving distance of the transport device 301 is short.

The group creation procedure may be a procedure of classifying the pairs for each characteristic of the transport device 301. The characteristics include, for example, the size of the transport device 301, the shape of the transport device 301, an allowable loading amount of the transport device 301, and the like. The group creation procedure may be a procedure of classifying the pairs for each type of the transport object. The group creation procedure is used when, for example, the types of transport objects that can be transported by the transport device 301 are limited. According to the group creation procedure, since the types of the transport objects are limited, there is an effect of assigning the transport device 301 capable of efficiently transporting the transport object to the transport object.

The decision unit 202 decides whether the load of each SD pair satisfies the decision criterion (step S103). As described above, the decision criterion represents a criterion of determining whether to perform the group transport or the individual transport. In the case where the load satisfies the decision criterion (YES in step S103), the decision unit 202 determines to perform the group transport (step S105). In the case where the load does not satisfy the decision criterion (NO in step S103), the decision unit 202 determines to perform the individual transport (step S104). For example, the decision unit 202 determines to perform the group transport in the case of determining that the load is high, and determines to perform the individual transport in the case of determining that the load is not high.

The decision unit 202 may select a pair having a high transport load from among the SD pairs. The decision unit 202 may select the SD pair having the highest transport load from the rankings.

For convenience of description, the decision unit 202 is assumed to select an SD pair having the highest load (hereinafter expressed as “SD pair 1”).

After step S105, the determination unit 203 specifies the current transport mode related to the SD pair 1 (step S111 in FIG. 5). That is, the decision unit 202 specifies whether the mode of the transport operation performed in the SD pair 1 is the individual transport or the group transport.

For example, the determination unit 203 may specify the transport mode of each SD pair, using the transport path information stored in the transport path information storage unit 155 (illustrated in FIG. 12). In this case, the determination unit 203 reads the transport mode associated with the SD pair 1 from the transport path information storage unit 155.

The determination unit 203 may specify the transport mode of the SD pair on the basis of an image of the target system 101 captured by the detection device 156 or the like. Alternatively, the determination unit 203 may specify the transport mode of the SD pair on the basis of the position of each transport device 301. The processing of specifying the transport mode is not limited to the above-described example.

The decision unit 202 specifies the current transport mode performed in the SD pair (step S111), and decides whether the specified transport mode is the group transport or the individual transport (step S112).

In the case where the current transport mode is the group transport (YES in step S112), the determination unit 203 terminates the processing. YES in step S112 indicates that the transport processing performed in the SD pair 1 is maintained as the group transport.

In the case where the current transport mode is the individual transport (NO in step S112), the determination unit 203 determines the transport path between the transport source and the transport destination in the SD pair 1 according to the predetermined path calculation procedure on the basis of the layout information (illustrated in FIG. 10) (step S113).

The determination unit 203 may determine the transport path on the basis of, for example, a length of the transport path, a transport time, interference in the plurality of transport devices 301, interference between an obstacle and the transport device 301 in the target system 101, or the like. For example, the determination unit 203 may determine a path having the shortest transport path, a path having the shortest transport time, a path having the minimum number of times of interference, a path having the minimum interference time, or the like.

Next, the determination unit 203 calculates the number of transport devices 301 (hereinafter expressed as “requested number”) required to form the group transport in the SD pair 1 (step S114). Moreover, the decision unit 202 calculates the number of transport devices 301 (hereinafter expressed as “the number of individual transport devices”) that performs the individual transport in the target system 101.

The instruction unit 204 decides whether the number of individual transport devices is sufficient to form the group transport (step S115). Specifically, the instruction unit 204 compares the requested number with the number of individual transport devices. In the case where the number of individual transport devices is equal to or larger than the requested number (YES in step S115), the transport devices 301 can form the group transport. In other words, it can be said that, in the case where the number of individual transport devices is equal to or larger than the requested number, the instruction unit 204 determines to change the transport mode in the SD pair 1 from the individual transport to the group transport.

Next, the instruction unit 204 determines the transport devices 301 that perform the group transport (step S116). In other words, the instruction unit 204 determines the transport devices 301 that form the transport path in the group transport.

For example, the instruction unit 204 may select the transport device 301 close to the transport path and assign the group transport to the selected transport device 301. The instruction unit 204 may calculate the distance from the transport path to the transport device 301, select the transport device 301 on the basis of the distance, and assign the group transport to the selected transport device 301. For example, the instruction unit 204 may select the transport device 301 in ascending order of the distance to the transport device 301. In this case, according to the processing, for example, the group transport can be implemented with a short moving distance, a short moving time, or less interference.

For example, the instruction unit 204 may randomly select the transport device 301 and assign the group transport to the selected transport device 301. According to this processing, since the number of transport devices 301 for which the transport mode is changed from the individual transport to the group transport is reduced, there is an effect of reducing the cost required to change the transport mode from the individual transport to the group transport.

The processing of assigning the transport device 301 is not limited to the above-described example.

The instruction unit 204 instructs the determined transport devices 301 to perform the group transport (step S117). The instruction unit 204 may instruct the transport devices 301 to which the group transport is assigned to move as instructed to form a group forming the group transport.

The instruction unit 204 may determine the position of each transport device 301 and the orientation of the transport device 301. In this case, the instruction unit 204 may determine the position of the transport device 301 to which the group transport is determined to be assigned. The instruction unit 204 may determine the orientation of the transport device 301 such that the direction in which the transport device 301 transports the transport object on the transport path on which the group transport is performed matches the transportable direction by the transport unit 302 in the transport device 301. Then, the instruction unit 204 instructs the transport device 301 to perform the transport operation according to the orientation at the position.

After step S104 or in the case of NO in step S115, the instruction unit 204 instructs the transport device 301 to perform the individual transport for the SD pair (step S118).

The instruction unit 204 instructs the transport device 301 to which the individual transport is assigned to transport the transport object from the transport source to the transport destination. The instruction unit 204 may instruct the transport device 301 different from the transport devices 301 that perform the group transport to transport the transport object from the transport source to the transport destination.

For example, the instruction unit 204 may select a plurality of SD pairs having a low load among a plurality of SD pairs and assign one transport device 301 to the plurality of selected SD pairs. According to such processing, there is an effect of maintaining the transport performance as a whole to be high while transporting the transport object with high transport performance for the SD pair with a high load.

For example, the instruction unit 204 may assign the group transport and the individual transport to one SD pair. In this case, the transport mode in the one SD pair includes the group transport and the individual transport. In the one SD pair, for example, the individual transport may be performed in a subsequent process after the group transport is performed, or the group transport may be performed in a subsequent process after the individual transport is performed. According to such processing, even in the case where the number of transport devices 301 is small, there is an effect of achieving highly efficient transport.

In the case of performing the individual transport in the SD pair, the number of transport devices 301 assigned to the individual transport is not limited to one and may be plural.

Next, an operation of the transport device 301 in the case of group transport will be described with reference to FIG. 6. FIG. 6 is a flowchart illustrating an example of a flow of the operation in the transport device 301 in the case of group transport. For convenience of description, the processing illustrated in FIG. 6 is referred to as “FLOW-B”.

In the case of the group transport, the control unit 304 in the transport device 301 receives the instruction regarding implementation of the group transport from the transport control device 201 (step S201). The control unit 304 may receive an instruction indicating the position of the transport device 301 and the direction of the transport direction.

The control unit 304 controls the moving unit 303 in the transport device 301 according to the received instruction. This operation will be specifically described.

The transport device 301 detects the outside of the transport device such as a marker, an obstacle, a distance between the transport device and another transport device, and the like, using the detection unit 305 such as an infrared sensor, an ultrasonic sensor, a Lidar, or a camera (step S202).

The control unit 304 estimates the position of the transport device of the control unit 304, using information of the detected distance or odometry (step S203). For example, the control unit 304 may estimate the position of the transport device of the control unit 304 according to a method such as a Kalman filter.

The control unit 304 controls the moving unit 303 to change the position of the transport device and the orientation of the transport device of the control unit 304, and the like according to the instruction (step S204). In other words, the control unit 304 controls the moving unit 303 such as a tire or a crawler to approach a target position and a target posture according to the instructed transport mode. In other words, the transport device 301 moves to the position where the transport operation is to be performed according to the instructed transport mode, and adjusts the orientation of the transport device 301 so as to be able to transport the transport object in a traveling direction of the transport path. In the case where the transport device 301 includes the rotating unit 306 capable of adjusting the orientation of the transport unit 302, the transport device 301 may control the rotating unit 306 to be able to transport the transport object along the traveling direction of the transport path.

The control unit 304 detects the position of the transport object using the detection unit 305 such as an infrared sensor, a push switch, or a camera (step S205). Specifically, the control unit 304 detects that the transport object arrives at the transport device of the control unit 304. The transport device can create information regarding the position of the transport object on the basis of the detected position.

The control unit 304 controls the transport unit 302 such as a belt or a tire such that the transport object travels along the traveling direction of the transport path (step S206).

The control unit 304 detects the position of the transport object using the detection unit 305 such as an infrared sensor, a push switch, or a camera (step S207). The control unit 304 detects that the transport object is away from the transport device of the control unit 304 on the basis of the detected position. The control unit 304 may further control the mechanism so that the transport object is placed on the transport destination. The transport destination may be, for example, a predetermined place such as a device or a shelf, or a position on the shelf. The transport destination may have the mechanism such as a manipulator that grasps the transport object and places the transport object at a predetermined position.

The group transport can be implemented by the above-described processing. Further, the number of transport objects on the transport path may be one or plural. The transport objects may be transported in parallel on a plurality of transport paths.

Next, an operation of the transport device 301 in the case of individual transport will be described with reference to FIG. 7. FIG. 7 is a flowchart illustrating an example of a flow of operation in the transport device 301 in the case of individual transport. For convenience of description, the processing illustrated in FIG. 7 is referred to as “FLOW-C”.

The control unit 304 receives the instruction to perform the individual transport from the transport control device 201 (step S301).

The control unit 304 controls the moving unit 303 and the transport unit 302 to receive the transport object at the transport source, transport the received transport object to the transport destination, and deliver the transport object to the transport destination, in accordance with the received instruction. This processing will be specifically described.

The control unit 304 controls the moving unit 303 to move to the transport source in accordance with the instruction (step S302). For example, the control unit 304 may control the moving unit 303 such as a tire to move at a predetermined speed (cruise speed, maximum speed, speed limit defined by an area or a path, or the like).

The control unit 304 receives the transport object at the transport source (step S303). The control unit 304 detects the position of the transport object using the detection unit 305 such as an infrared sensor, a push switch, or a camera.

The control unit 304 controls the moving unit 303 to move to the transport destination (step S304). For example, the control unit 304 may control the moving unit 303 such as a tire to move at a predetermined speed (cruise speed, maximum speed, speed limit defined by an area or a path, or the like).

The control unit 304 controls the transport unit 302 and the like to deliver the transport object to the transport destination (step S305). In the case where the transport device 301 includes a picking unit such as a manipulator, the control unit 304 may control the picking unit to deliver the transport object to the transport destination. For example, the transport destination is a predetermined position (such as a shelf).

Moreover, FLOW-A and FLOW-B may be sequentially executed. FLOW-A and FLOW-C may be sequentially executed. According to such processing, there is an effect that management of these pieces of processing is easy. Alternatively, FLOW-A to FLOW-C may be executed in parallel.

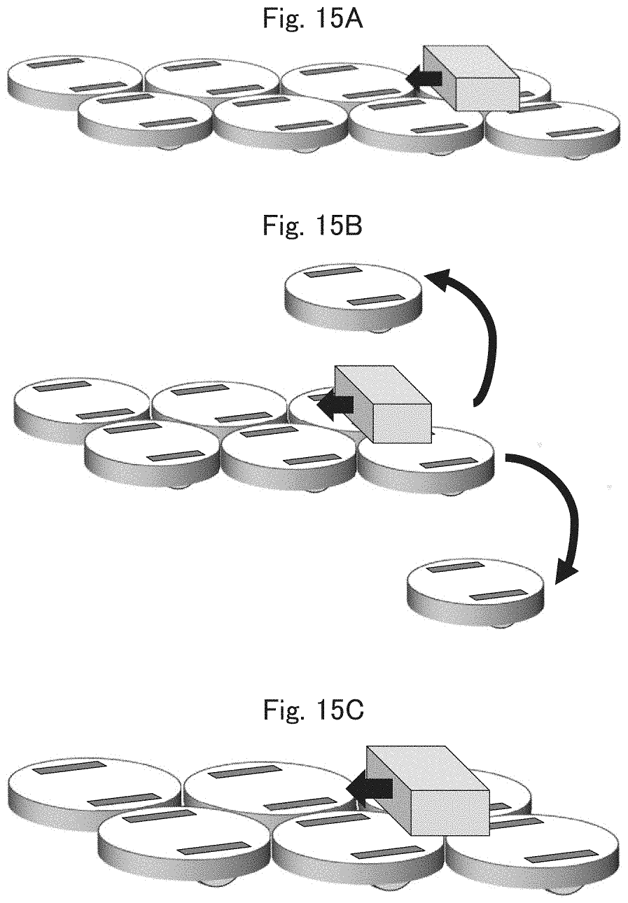

In FLOW-B, some of the transport devices 301 constituting the transport path may be assigned to another SD pair before the transport object arrives at the transport destination via the transport path. The processing will be specifically described with reference to FIGS. 15A to 15C. FIGS. 15A to 15C are views conceptually illustrating an example of the operation flow for controlling the transport devices 301 by group transport. In FIGS. 15A to 15C, it is assumed that time transitions in order of FIG. 15A→FIG. 15B→FIG. 15C.

Referring to FIG. 15A, the transport path in the group transport includes eight transport devices 301. The transport object arrives at the transport path from the right side of FIG. 15A. Then, the control unit 304 performs control to transport the transport object along the direction of the transport path. In FIG. 15A, the direction of the transport path is the left direction in FIG. 15A. The control unit 304 controls the transport unit 302 so that the transport object advances in the left direction in FIG. 15A. That is, the control unit 304 controls the transport unit 302 so that the transport object moves to the adjacent control device on the left.

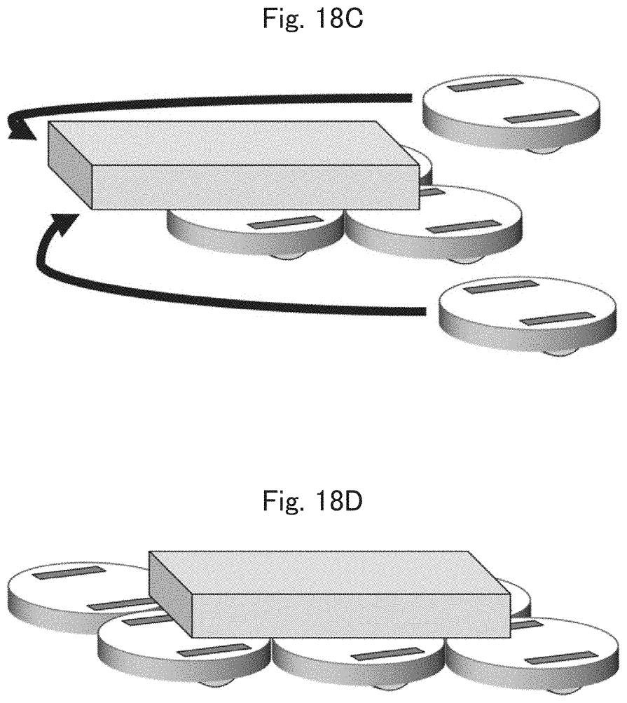

Referring to FIG. 15B, the control unit 304 in the transport device 301 that has completed the operation of moving the transport object to the left is separated from the transport path. In this case, the transport device 301 may move to form a transport path in another transport path. Alternatively, the transport device 301 may perform an operation in the individual transport. Alternatively, the transport device 301 may move to the left end of the transport path illustrated in FIG. 15B and constitute the transport path on the left end (to be described in detail with reference to FIGS. 18A to 18D). The control unit 304 in the transport device 301 may control the moving unit 303 to move to the left end of the transport path illustrated in FIG. 15B and change the orientation of the transport device of the control unit 304 along the transport path. Alternatively, the control unit 304 in the transport device 301 may control the moving unit 303 to move to the left end of the transport path illustrated in FIG. 15B, and may control the rotating unit 306 such that the transportable direction by the transport unit 302 goes along the transport path from the transport source to the transport destination.

FIG. 15C illustrates a state in which some of the transport devices 301 constituting the transport path are separated from the transport path. In this case, the transport device 301 illustrated on the right side of FIG. 15C executes the above-described processing with reference to FIG. 15A.

According to the processing as described with reference to FIGS. 15A to 15C, there is an effect of easily changing the transport mode. Moreover, according to the processing as described with reference to FIGS. 15A to 15C, there is an effect of promptly coping with the load variation.

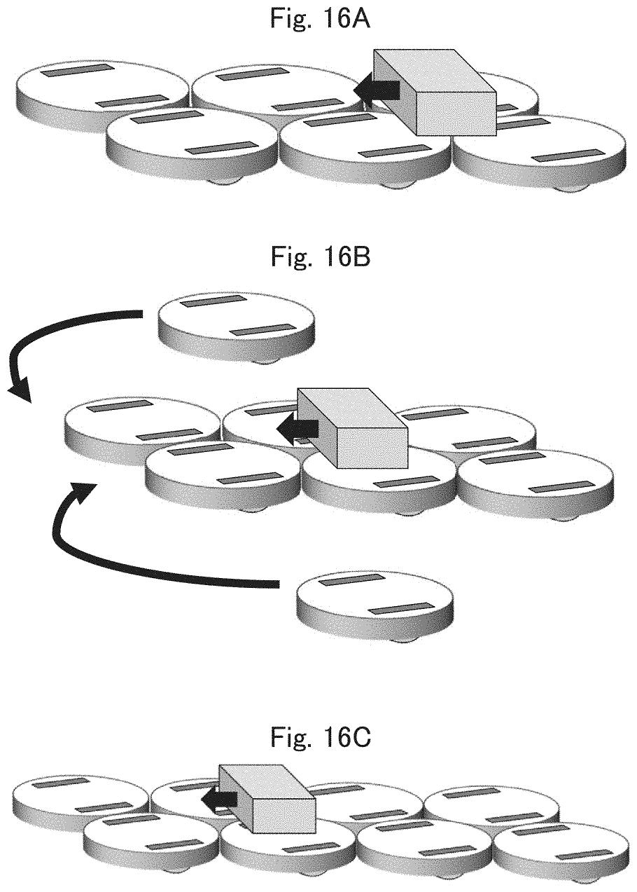

Moreover, the transport device 301 may start an operation of transporting the transport object while forming the transport path in the group transport. The operation will be described with reference to FIGS. 16A to 16C. FIGS. 16A to 16C are views conceptually illustrating an example of the operation flow for controlling the transport devices 301 by the group transport. In FIGS. 16A to 16C, it is assumed that time transitions in order of FIG. 16A→FIG. 16B→FIG. 16C. The processing illustrated in FIGS. 16A to 16C can also be said to represent processing of starting the transport operation before completing the operation of forming the transport path.

For convenience of description, it is assumed that the number of the transport devices 301 constituting the transport path is eight. Of the eight transport devices 301, the six transport devices 301 are assumed to have completed the operation of forming the transport path. Of the eight transport devices 301, the two transport devices 301 are assumed to have not completed the operation of forming the transport path.

Referring to FIG. 16A, the transport object arrives at the transport path from the right side of FIG. 16A. However, two transport devices 301 have not completed the operation of forming the transport path at that timing. Then, the transport devices 301 transport the transport object along the direction of the transport path. In FIG. 16A, the direction of the transport path is the left direction in FIG. 16A. The control unit 304 controls the transport unit 302 so that the transport object advances in the left direction in FIG. 16A. That is, the control unit 304 controls the transport unit 302 so that the transport object moves to the adjacent transport device 301 on the left.

Referring to FIG. 16B, during the transport operation of the transport object, the two transport devices 301 move to the left end of the transport path so as to form the transport path. The two transport devices 301 may move so as to be able to transport the transport object in the direction along the transport path. In this case, it can also be said that the control units 304 in the two transport devices 301 control the moving units 303 to move to the positions to be able to transport the transport object in the direction.

Referring to FIG. 16C, the two transport devices 301 stop moving at the left end of the transport path. With this operation, the transport devices 301 complete the operation of forming the transport path. The two transport devices 301 execute the processing of transporting the transport object as described with reference to FIG. 16A. Therefore, the control units 304 in the transport devices 301 move to form the transport path and transport the transport object at the positions after the movement. Then, the control units 304 of the transport devices 301 control the moving units 303 and the transport units 302 to move to form the transport path in the direction in which the transport object moves on the transport path in response to completion of the transport. By such processing, there is an effect of efficiently transporting the transport object even in the case where the number of transport devices 301 is limited.

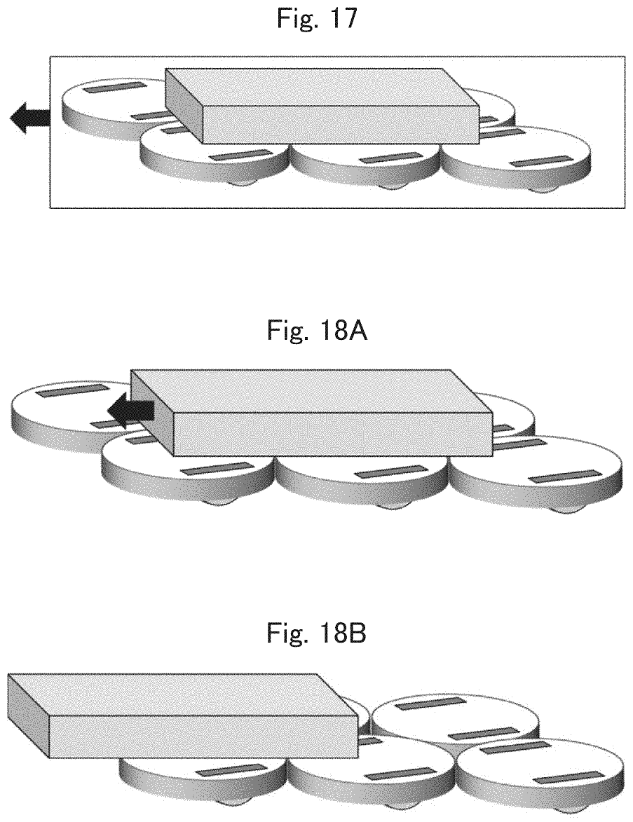

Next, an example of an operation in a case where the transport object is larger than the transport device 301 will be described with reference to FIG. 17. FIG. 17 is a view conceptually illustrating an example of an operation flow for controlling the transport devices 301.

In the case where the transport object is larger than the transport device 301, the plurality of transport devices 301 may transport the transport object while cooperating with each other. The plurality of transport devices 301 may move from the transport source to the transport destination while loading the transport object in cooperation. In this case, the plurality of transport devices 301 moves from the transport source to the transport destination while maintaining the transport mode as illustrated in FIG. 17. The control unit 304 may control the moving unit 303 and the transport unit 302 so as to move while transporting the transport object from the transport source to the transport destination in the mode where the plurality of transport devices 301 is connected. With such an operation, there is an effect of eliminating the necessity of preparing the transport device 301 having transport capacity according to the characteristics of the transport object. In other words, with such an operation, there is an effect of reducing the resources related to the transport device 301.

Next, an example of an operation of transport processing of the group transport will be described with reference to FIGS. 18A to 18D. FIGS. 18A to 18D are views conceptually illustrating an example of an operation flow for controlling the transport devices 301 by the group transport.

FIGS. 18A to 18D are views conceptually illustrating an example of an operation flow for controlling the transport devices 301. In FIGS. 18A to 18D, it is assumed that time transitions in order of FIG. 18A→FIG. 18B→FIG. 18C→FIG. 18D. The transport object moves from the right side to the left side in FIGS. 18A to 18D. In other words, the direction of the transport path is assumed to be the left direction in FIGS. 18A to 18D.

In the case where the transport object is larger than the transport device 301, the plurality of transport devices 301 may transport the transport object while forming the transport path for implementing the group transport.

FIG. 18A illustrates the transport path formed by the six transport devices 301. The transport object arrives at the transport path from the right side of FIG. 18A.

Referring to FIG. 18B, the transport devices 301 transport the transport object along the direction of the transport path. The instruction unit 204 controls the transport units 302 so that the transport object advances in the left direction in FIG. 18B. That is, the instruction unit controls the transport units 302 so that the transport object moves to the adjacent transport devices 301 on the left. FIG. 18B illustrates a state in which the transport devices 301 at the right end complete the operation of moving the transport object to the adjacent transport devices 301 on the left.

FIG. 18C illustrates a state in which the transport devices 301 that have completed the transport operation are moving in the direction of forming the transport path. In this case, the transport devices 301 that have completed the transport operation move to the left of the transport devices 301 illustrated at the left end in FIG. 18C.

FIG. 18D illustrates a state in which the transport devices 301 that have completed the transport operation further completes the movement operation to form the transport path. The transport devices 301 perform the operation of transporting the transport object at the moved destination.

According to such processing, even in the case where the transport object is larger than the transport device 301, there is an effect of achieving the group transport.

Alternatively, in the case where the transport object is smaller than the transport device 301, the plurality of transport devices 301 may transport the transport object while forming the transport path for implementing the group transport according to the processing in FIGS. 18A to 18. According to the processing, there is an effect of implementing the group transport by a smaller number of transport devices 301.

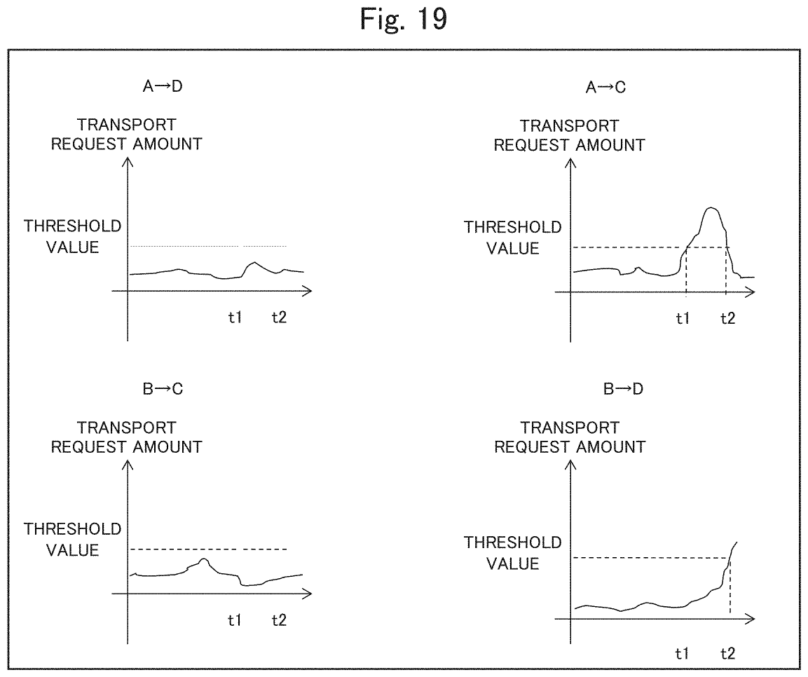

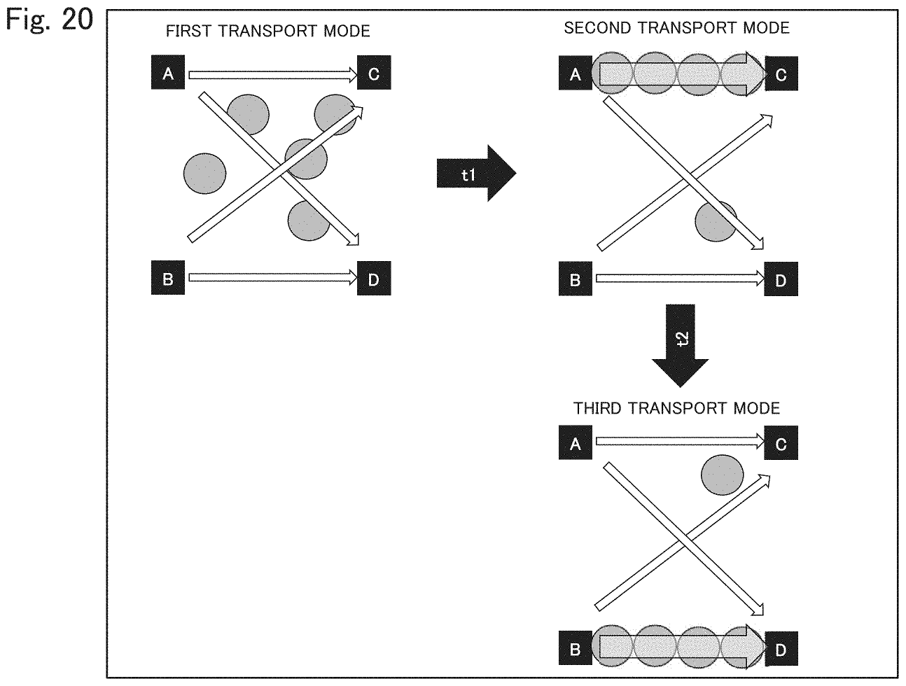

Next, an example of an operation of changing assignment between the group transport and the individual transport will be described with reference to FIGS. 19 and 20. FIG. 19 is a diagram conceptually illustrating time-series transition of the transport request amount. FIG. 20 is a diagram conceptually illustrating a change in the transport mode in the case where the number of transport devices 301 is fixed.

FIG. 19 is a diagram conceptually illustrating time-series transition of the transport request amount between SDs. “A→D” in the upper left of FIG. 19 is a graph conceptually illustrating transition of the transport request amount between the workstation A and the workstation D. “A→D” in the upper right of FIG. 19 is a graph conceptually illustrating transition of the transport request amount between the workstation A and the workstation C. “B→C” in the lower left of FIG. 19 is a graph conceptually illustrating transition of the transport request amount between the workstation B and the workstation C. “B→D” in the lower right of FIG. 19 is a graph conceptually illustrating transition of the transport request amount between the workstation B and the workstation D. In any of the graphs, the horizontal direction represents time, and the time transitions rightward. In any of the graphs, the vertical direction represents the transport request amount, and the transport request amount increases upward.

In the example illustrated in FIG. 20, the transport mode is individual transport during a low load and is group transport during a high load. In FIG. 20, it is assumed that the time transitions in order of the first transport mode→the second transport mode→the third transport mode.

For convenience of description, the target system 101 includes the workstation A, the workstation B, the workstation C, and the workstation D. The target system 101 includes five transport devices 301. In the target system 101, the transport devices 301 receive the transport object from the workstation A or the workstation B. In other words, the workstation A and the workstation B are the transport sources. The transport devices 301 are assumed to transport the transport object to the workstation C or the workstation D. In other words, the workstation C and the workstation D are the transport destinations.

For convenience of description, it is assumed that FLOW-A is started with an event that the transport request amount exceeds a predetermined threshold value and an event that the transport request amount falls below the predetermined threshold value as triggers. In FLOW-A, whether each SD pair has a high load or a low load is decided, and whether to perform the individual transport or the group transport is determined on the basis of the decision result. The predetermined threshold value may be calculated on the basis of, for example, the transport capacity of the transport device 301 and the transport request amount. In other words, the predetermined threshold value represents a value for deciding the transport mode. The transport capacity is, for example, the amount, weight, number, or the like of packages that can be transported by the transport device 301 per unit time.

The first transport mode of FIG. 20 represents a state in which the individual transport is assigned to all of the five transport devices 301. In other words, the transport modes for the following SD pairs are all individual transport:
an SD pair constituted by the workstation A and the workstation C,
an SD pair constituted by the workstation A and the workstation D,
an SD pair constituted by the workstation B and the workstation C, and
SD pair constituted by the workstation B and the workstation D.

As illustrated in “A→C” in FIG. 19, it is assumed that the transport request amount for the SD pair constituted by the workstation A and the workstation C exceeds the predetermined threshold value at timing t1. In other words, the operation illustrated in FLOW-A is started with an event occurring at timing t1 as a trigger.

For convenience of description, the instruction unit 204 is assumed to change the transport mode for the SD pair constituted by the workstation A and the workstation C from the individual transport to the group transport. In the case where the number of transport devices 301 required to form the transport path is four, the group transport cannot be assigned to an SD pair different from the SD pair configured by the workstation A and the workstation C.

As illustrated in “A→D”, “B→C”, and “B→D” in FIG. 19, the transport request amount for the SD pair different from the SD pair constituted by the workstation A and the workstation C is smaller than the predetermined threshold value at timing t1. In this case, the decision unit 202 changes the transport mode for the SD pair constituted by the workstation A and the workstation C from the individual transport to the group transport.

In the example illustrated in the second transport mode of FIG. 20, since the group transport in the SD pair can be formed using the four transport devices 301, the instruction unit 204 in the four transport devices 301 controls the moving units 303 to form the transport path. As a result, as illustrated in the second transport mode of FIG. 20, the four transport devices 301 move to the positions forming the transport path. Since every load for the SD pair different from the SD pair configured by the workstation A and the workstation C is low, the remaining one transport device 301 executes the transport processing regarding the three SD pairs. That is, the remaining one transport device 301 performs the individual transport for the three SD pairs. Therefore, each of the five transport devices 301 performs the transport processing according to FLOW-B or the transport processing according to FLOW-C.

Next, as illustrated in “A→C” in FIG. 19, it is assumed that the transport request amount for the SD pair constituted by the workstation A and the workstation C falls below the predetermined threshold value at timing t2. Next, as illustrated in “B→D” in FIG. 19, it is assumed that the transport request amount for the SD pair constituted by the workstation B and the workstation D exceeds the predetermined threshold value at timing t2. The operation illustrated in FLOW-A is started with an event occurring at timing t2 as a trigger.

The instruction unit 204 changes the transport mode for the SD pair constituted by the workstation B and the workstation D to the group transport on the basis of the transport request amount. Moreover, the instruction unit 204 changes the transport mode for the SD pair constituted by the workstation A and the workstation C to the individual transport. This is because in the case where the number of the transport devices 301 is five, the group transport cannot be assigned to two SD pairs.

The control unit 304 controls the moving unit 303 and the transport unit 302 to change the transport mode for the SD pair in accordance with the instruction. Specifically, among the five transport devices 301, the control units 304 in the four transport devices 301 control the moving units 303 to move to positions where the transport path for the SD pair constituted by the workstation B and the workstation D is formed, for example. That is, the four transport devices 301 move to the positions forming the transport path. As a result, as illustrated in the third transport mode of FIG. 20, the transport path for the SD pair constituted by the workstation B and the workstation D is formed. The remaining one transport device 301 executes processing related to the individual transport. Therefore, each of the five transport devices 301 performs the transport processing according to FLOW-B or the transport processing according to FLOW-C.

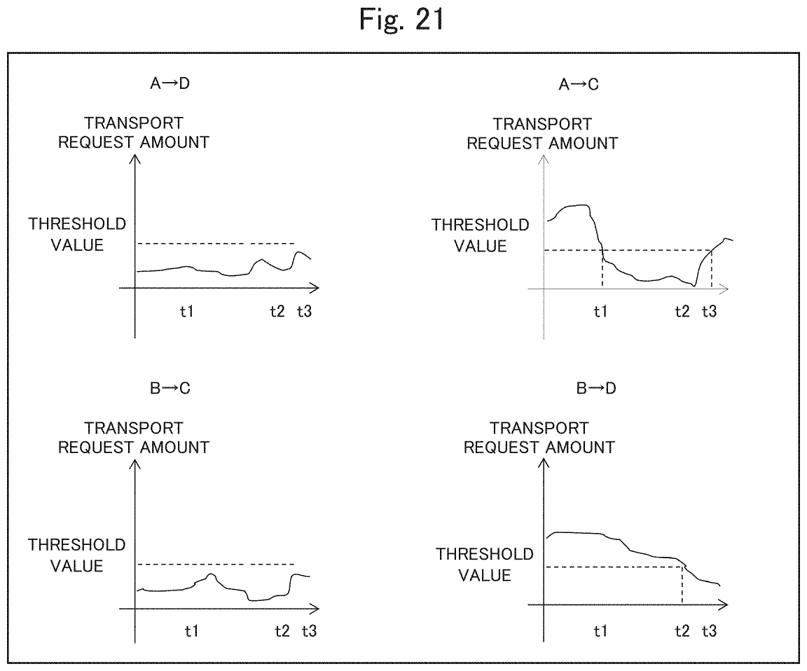

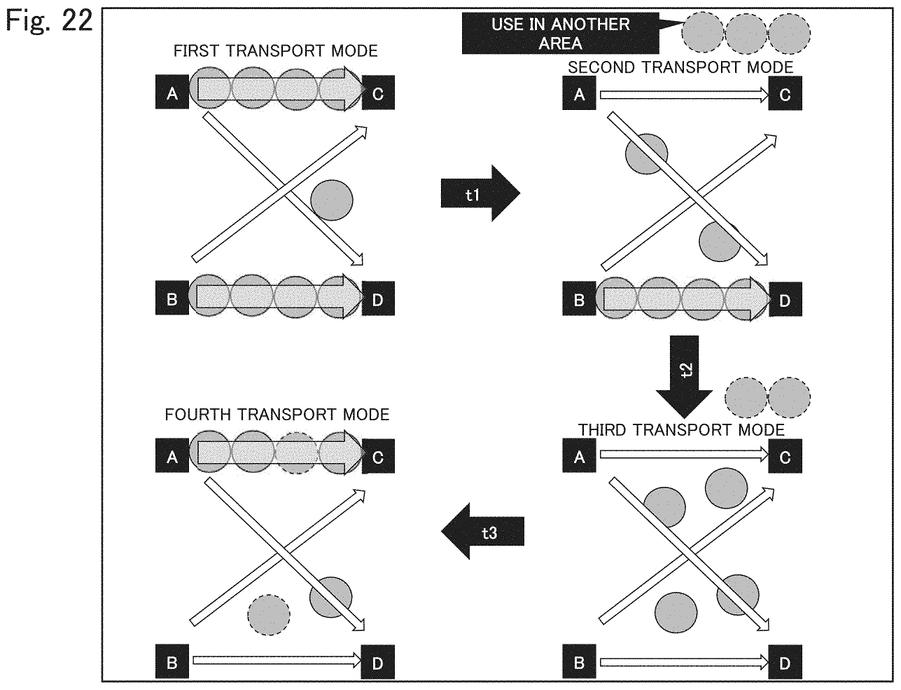

Moreover, an example of an operation of changing assignment between the group transport and the individual transport will be described with reference to FIGS. 21 and 22. FIG. 21 is a diagram conceptually illustrating time-series transition of a transport request amount. FIG. 22 is a diagram conceptually illustrating a change in a transport mode in a case where the number of transport devices 301 is variable.

FIG. 21 is a diagram conceptually illustrating time-series transition of the transport request amount between SDs. “A→D” in the upper left of FIG. 21 is a graph conceptually illustrating transition of the transport request amount between the workstation A and the workstation D. “A→C” in the upper right of FIG. 21 is a graph conceptually illustrating transition of the transport request amount between the workstation A and the workstation C. “B→C” in the lower left of FIG. 21 is a graph conceptually illustrating transition of the transport request amount between the workstation B and the workstation C. “B→D” in the lower right of FIG. 21 is a graph conceptually illustrating transition of the transport request amount between the workstation B and the workstation D. In any of the graphs, the horizontal direction represents time, and the time transitions rightward. In any of the graphs, the vertical direction represents the transport request amount, and the transport request amount increases upward.

In the operation example illustrated in FIG. 22, the transport mode is individual transport during a low load and is group transport during a high load. In FIG. 22, it is assumed that the time transitions in order of the first transport mode→the second transport mode→the third transport mode→the fourth transport mode.

For convenience of description, the target area includes the workstation A, the workstation B, the workstation C, and the workstation D. The target area includes nine transport devices 301. In the target system 101, the transport devices 301 receive the transport object from the workstation A or the workstation B. In other words, the workstation A and the workstation B are the transport sources. The transport devices 301 are assumed to transport the transport object to the workstation C or the workstation D. In other words, the workstation C and the workstation D are the transport destinations.

For convenience of description, it is assumed that FLOW-A is started with an event that the transport request amount exceeds a predetermined threshold value and an event that the transport request amount falls below the predetermined threshold value as triggers. In FLOW-A, whether each SD pair has a high load or a low load is decided, and whether to perform the individual transport or the group transport is determined on the basis of the decision result. The predetermined threshold value may be calculated on the basis of, for example, the transport capacity of the transport device 301 and the transport request amount. In other words, the predetermined threshold value represents a value for determining the transport mode. The transport capacity is, for example, the amount, weight, number, or the like of packages that can be transported by the transport device 301 per unit time.

The target area illustrated in the first transport mode of FIG. 22 includes nine transport devices 301. The target system 101 illustrated in the second transport mode of FIG. 22 includes six transport devices 301. The target area illustrated in the third transport mode of FIG. 22 includes four transport devices 301. The target area illustrated in the fourth transport mode of FIG. 22 includes six transport devices 301.

In the example illustrated in the first transport mode of FIG. 22, the four transport devices 301 form the transport path for the SD pair constituted by the workstation A and the workstation C. Then, the four transport devices 301 form the transport path for the SD pair constituted by the workstation B and the workstation D. That is, the eight transport devices 301 perform the group transport. The remaining one transport device 301 performs the individual transport.

As illustrated in “A→C” in FIG. 21, it is assumed that the transport request amount for the SD pair constituted by the workstation A and the workstation C falls below the predetermined threshold value at timing t1. The operation illustrated in FLOW-A is started with an event occurring at timing t1 as a trigger.

The instruction unit 204 changes the transport mode for the SD pair constituted by the workstation A and the workstation C from the group transport to the individual transport. In other words, the instruction unit 204 assigns the individual transport to the four transport devices 301 constituting the transport mode.

The group transport is assigned to the SD pair constituted by the workstation B and the workstation D, and further, as illustrated in “A→D”, “A→C”, and “B→C” in FIG. 21, the transport request amounts related to the other three SD pairs are smaller than the predetermined threshold value. In this case, the decision unit 202 may control the transport device 301 performing the individual transport to perform the transport processing in another area. As illustrated in the second transport mode of FIG. 22, the instruction unit 204 instructs, for example, three transport devices 301 to perform the transport processing in another area.

As a result of the processing, the transport mode for the SD pair constituted by the workstation B and the workstation D remains as the group transport, as illustrated in the second transport mode in FIG. 22. The remaining two transport devices 301 perform the individual transport. Therefore, each of the six transport devices 301 performs the transport processing according to FLOW-B or the transport processing according to FLOW-C in the target area.

As illustrated in “B→D” in FIG. 21, it is assumed that the transport request amount for the SD pair constituted by the workstation B and the workstation D falls below the predetermined threshold value at timing t2. The operation illustrated in FLOW-A is started with an event occurring at timing t2 as a trigger.

The instruction unit 204 changes the transport mode for the SD pair constituted by the workstation B and the workstation D from the group transport to the individual transport. In other words, the instruction unit 204 assigns the individual transport to the four transport devices 301 constituting the transport mode.

As illustrated in FIG. 21, all the transport request amounts related to the four SD pairs fall below the predetermined threshold value at timing t2. In this case, the decision unit 202 may control the transport device 301 performing the individual transport to perform the transport processing in another area. As illustrated in the third transport mode of FIG. 22, the decision unit 202 controls, for example, two transport devices 301 to perform the transport processing in another area.

As a result of the processing, as illustrated in the third transport mode of FIG. 22, the four transport devices 301 perform the individual transport. Therefore, each of the four transport devices 301 performs the transport processing according to FLOW-C in the target area.

As illustrated in “A→C” in FIG. 21, it is assumed that the transport request amount for the SD pair constituted by the workstation A and the workstation C exceeds the predetermined threshold value at timing t3. The operation illustrated in FLOW-A is started with an event occurring at timing t3 as a trigger.

The instruction unit 204 changes the transport mode for the SD pair constituted by the workstation A and the workstation C from the individual transport to the group transport. In other words, the instruction unit 204 assigns the group transport so as to form the transport path for the SD pair to the four transport devices 301 that have performed the individual transport. In this case, the instruction unit 204 decides that the transport in the target area cannot be performed with four transport devices 301, and determines that the transport devices 301 in another area move into the target area.

As a result of the processing, as illustrated by the dotted circle in the fourth transport mode in FIG. 22, the two transport devices 301 in charge of another area moves to the target area. Then, the four transport devices 301 form the transport path for the SD pair constituted by the workstation A and the workstation C. The remaining two transport devices 301 execute the processing related to the individual transport. Therefore, each of the six transport devices 301 performs the transport processing according to FLOW-B or the transport processing according to FLOW-C.

Next, modifications of the configuration of the transport device 301 will be described.

The plurality of transport devices 301 may be coupled in advance. In this case, the transport device 301 may have a coupling unit that is firmly coupled to another transport device 301 or an external fixed object. For example, in the case where a sufficient number of transport device 301 for performing the transport processing in the target system 101 is prepared, for example, two transport devices 301, three transport devices 301, or the transport devices 301 required to form the transport path may be coupled in advance. Alternatively, the transport device 301 including the transport unit 302 having a length sufficient for forming the transport path may be used for the group transport. The transport device 301 is, for example, a device having a conveyor as disclosed in PTL 5, a transport device as disclosed in PTL 1, or the like.

Further, in the case where it is necessary to flexibly cope with the change of the transport path, the transport device 301 may have a coupling unit that can be firmly coupled to another transport device and is easy to release the coupling. For example, the transport device 301 may be coupled to another transport device by the coupling unit in the case of forming the transport path, and may cancel the coupling in the case of changing the transport path to the individual transport.

The coupling unit is implemented by using, for example, the following component:
electromagnet,
a screw hole and a screw provided in a surface of the transport device 301,
a clamp that operates in reverse in the case of coupling and in the case of release, or
a mechanism such as a pin or a rod, and a recess or a hook in which irregularities fit the mechanism.

For example, when the individual transport is changed to the group transport, the control unit 304 may control the coupling unit to be coupled to another transport device or a fixed object. For example, when the group transport is changed to the individual transport, the control unit 304 may control the coupling unit so as to cancel the coupling with another transport device or a fixed object.

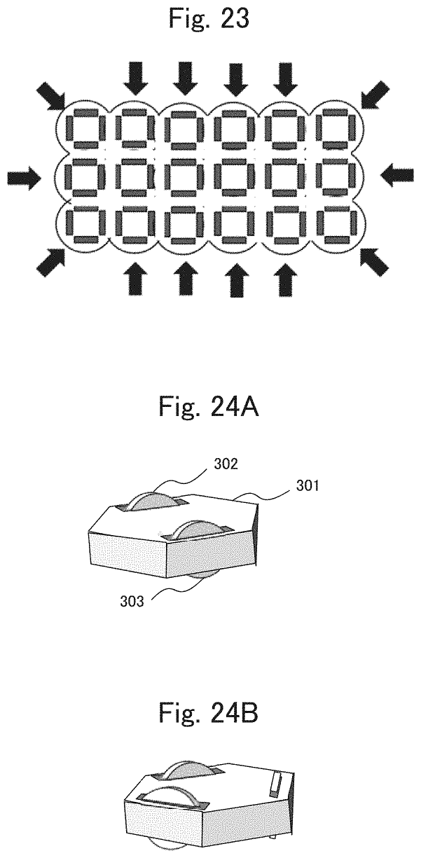

A coupling mode among the plurality of transport devices 301 in the case of the group transport will be described with reference to FIG. 23. FIG. 23 is a diagram conceptually illustrating an example of the coupling mode among the plurality of transport devices 301. The arrows in FIG. 23 represent directions of force. Each of the circular shapes in FIG. 23 represents one transport device 301.

Among the plurality of transport devices 301, each of the transport devices 301 on the outer side on the transport path may continuously apply a pushing force in a direction toward the transport device 301 on the inner side on the transport path. Moreover, the transport device 301 may continue to apply a pushing force in a direction toward a fixed object such as a wall and a column in the target system 101. In this case, the control unit 304 controls the moving unit 303 so that the mode of the transport path is maintained. With an operation, there is an effect of maintaining the transport path.

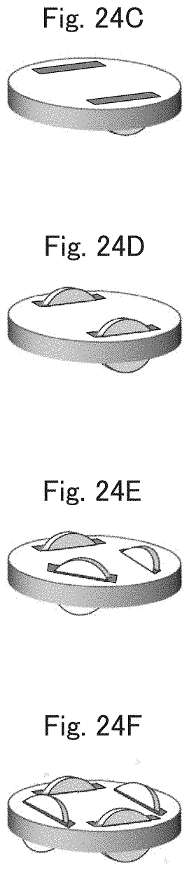

The configuration of the transport device 301 will be described with reference to FIGS. 24A to 24F. FIGS. 24A to 24F are perspective views illustrating configuration examples of the transport device 301.

The transport device 301 includes the transport unit 302 and the moving unit 303. The transport unit 302 and the moving unit 303 may share a component. The transport unit 302 and the moving unit 303 may share a rotation mechanism such as a motor or wheels, for example. That is, the transport unit 302 and the moving unit 303 may be implemented using a common component. By using the common component, the cost of the transport device 301 can be reduced, or the size of the transport device 301 can be reduced.

When the transport unit 302 and the moving unit 303 are implemented by the common component, the transport device 301 has a mechanism that does not transmit the operation of the moving unit 303 to the outside. This is to prevent the transport device 301 from moving when performing the operation of transporting the transport object using the transport unit 302.

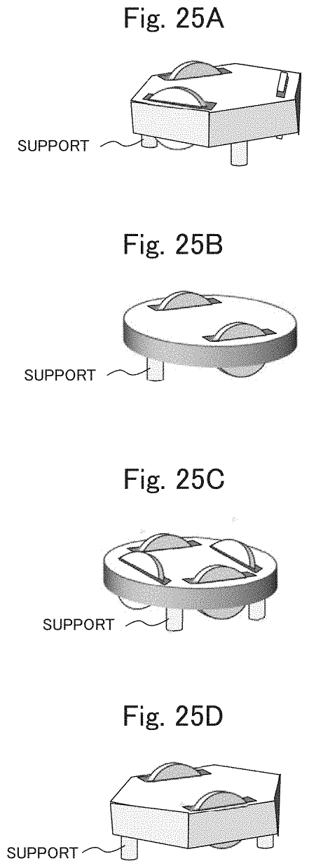

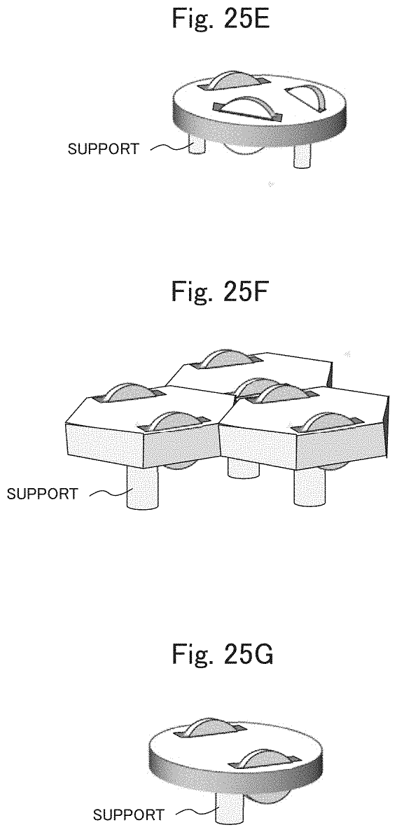

The mechanism will be described with reference to FIGS. 25A to 25G. FIGS. 25A to 25G are perspective views illustrating configuration examples of the transport device 301.

As illustrated in FIGS. 25A to 25G, the transport device 301 may have a support that floats the moving unit 303 from the floor (or separates the moving unit from a wall). The support is in contact with the wall, the floor, or the like during the transport operation. The support releases contact between the moving unit 303 and the outside in the case of the group transport. The support is not in contact with the wall, the floor, or the like during the moving operation.

The transport device 301 may have at least three supports in the lower part. In this case, there is an effect of stably fixing the transport device 301. Alternatively, as illustrated in FIG. 25A and the like, the transport device 301 may have two supports in the lower portion. In this case, as illustrated in FIG. 25F, the transport device 301 may eliminate the contact between the floor, the wall, or the like and the moving unit 303 while being coupled to another transport device. In this case, when carrying out the group transport, the control unit 304 controls the coupling unit to be coupled to another transport device or a fixed object, and controls the supports to release the contact between the moving unit 303 and the outside. According to such a mode, there is an effect of maintaining a stable state even with the small number of supports.

The transport device 301 may have a structure that comes into contact with a fixed object such as a wall or a column in the target system 101 during the transport operation. For example, the transport device 301 may have a support in contact with a fixed object in a direction in which the transport device is likely to fall. With such a mode, there is an effect of making the transport device 301 more stable.

As illustrated in FIGS. 25A to 25G, the shape formed by the side surface of the transport device 301 may be a circular shape such as a circle or an ellipse. Alternatively, the shape formed by the side surface of the transport device 301 may be a polygonal shape such as a triangle, a quadrangle, a pentagon, or a hexagon. The shape formed by the side surface of the transport device 301 in the target system 101 is not limited to one shape, and may be a plurality of shapes. For example, the target system 101 may include a transport device 301 having a square shape formed by the side surface and a transport device 301 having a regular octagonal shape formed by the side surface. The target system 101 may include a transport device 301 having an equilateral triangular shape formed by the side surface and a transport device 301 having a regular hexagonal shape formed by the side surface. With such a structure, there is an effect of reducing a gap among the plurality of transport devices 301. The shape formed by the side surface of the transport device 301 is not limited to the above-described example.

The transport device 301 may have a flexible member on the side surface. The flexible member is, for example, a soft elastic body such as a soft sponge, a brush, a soft resin, or a bubble buffering agent. The flexible member may include an elastic member such as a spring.

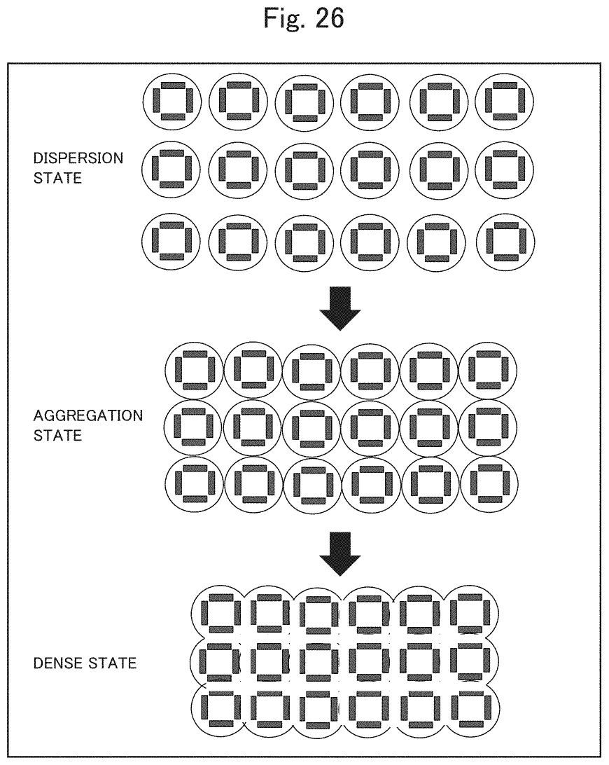

In the case where the transport devices 301 having the elastic body forms a group, the transport devices 301 on the outer side of the group perform the operation of pushing the transport devices 301 on the inner side of the group, as illustrated in FIG. 26. FIG. 26 is a diagram conceptually illustrating an example in which a plurality of transport devices 301 forms a group.

As illustrated in FIG. 26, in the case where the transport devices 301 having the elastic body forms a group, the transport devices 301 on the outer side of the group push the transport devices 301 on the inner side of the group. In other words, when performing the group transport, the control unit 304 controls the moving unit 303 so as to fill a gap between another transport device and the transport device of the control unit 304 performing the group transport with the elastic body. With the operation, there is an effect of reducing the gap between the plurality of transport devices 301 or the gap between the transport device 301 and the structure.

The dispersion state in FIG. 26 represents a state before the plurality of transport devices 301 forms a group. The aggregation state in FIG. 26 represents a state in which the plurality of transport devices 301 forms the group. The dense state in FIG. 26 represents a state in which the plurality of transport devices 301 forming the group forms a further dense group. Therefore, when the plurality of transport devices 301 operates as illustrated in FIG. 26, there is an effect of reducing the gap among the plurality of transport devices 301 using the flexible elastic body.

By reducing the gap, the plurality of transport devices 301 can prevent the package from falling through the gap.

In the above-described example, each operation has been described assuming that the transport device 301 and the transport control device 201 are separate bodies. However, the transport device 301 and the transport control device 201 may be implemented as one device.

The transport device 301 may execute the processing as described with reference to FIGS. 4 and 5 and the processing as described with reference to FIGS. 6 and 7. The transport device 301 may execute the processing as described with reference to FIGS. 4 and 5 and the processing as described with reference to FIGS. 6 and 7. The transport device 301 may execute some of the processing in the transport control device 201 described with reference to FIGS. 4 and 5.

Alternatively, the transport control device 201 may have a function of the control unit 304 in the transport device 301. In this case, the transport control device 201 controls the transport unit 302, the moving unit 303, and the like included in the transport device 301. In this case, the instruction unit 204 in the transport control device 201 can execute processing similar to the operations of the control unit 304 in the transport device 301. For example, the instruction unit 204 determines control content to be performed on the moving unit 303 and the transport unit 302 by executing processing similar to the operation of the control unit 304, and instructs the transport device 301 about the determined control content. The control content is, for example, information indicating the position of the control device and the orientation of the control device.

### Second Example Embodiment

Next, a second example embodiment of the present invention will be described.

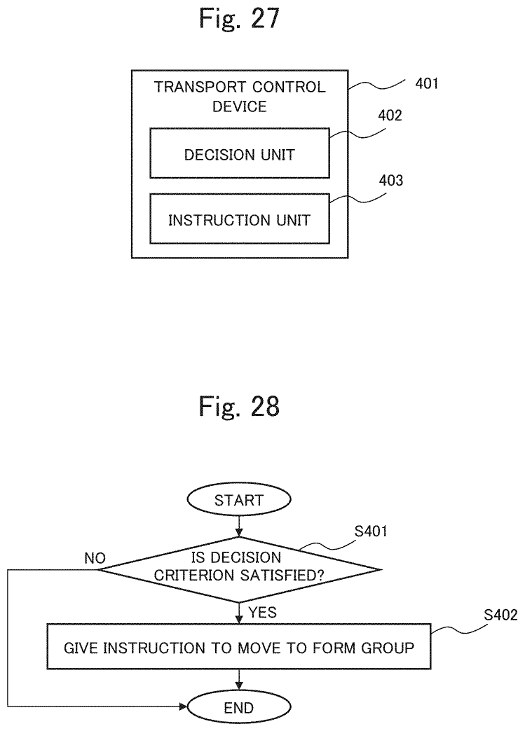

A configuration of a transport control device 401 according to the second example embodiment of the present invention will be described in detail with reference to FIG. 27. FIG. 27 is a block diagram illustrating an example of a configuration of the transport control device 401 according to the second example embodiment of the present invention.

The transport control device 401 according to the second example embodiment includes a decision unit 402 and an instruction unit 403.

The transport control device 401 is communicably connected to a transport device to be controlled via a communication network. The transport device is, for example, a device as described with reference to FIG. 2.

The transport control device 401 performs a transport operation performed in a target system while controlling the transport device. The target system is a system as described with reference to FIG. 3. The target system has a plurality of workstations.

Next, processing in the transport control device 401 according to the second example embodiment of the present invention will be described in detail with reference to FIG. 28. FIG. 28 is a flowchart illustrating an example of a flow of processing of the transport control device 401 according to the second example embodiment.

The decision unit 402 determines whether a load of the transport processing between the plurality of workstations satisfies a criterion for deciding necessity of implementation of group transport (step S401).

The load represents a load required for processing of transporting a transport object from a workstation that is a transport source to a workstation that is a transport destination, and represents, for example, a transport amount transported between the two workstations.

The criterion is a decision criterion for deciding a transport mode as described above. In other words, the criterion is a criterion for deciding the necessity of implementation of the group transport in which a plurality of transport devices performs transport in cooperation.

Therefore, the decision unit 402 decides whether to form a group of a plurality of transport devices according to whether the load of the transport processing for transporting the transport object from the transport source to the transport destination satisfies the criterion for deciding necessity of implementation of group transport in which the plurality of transport devices transports the transport object in cooperation.

In the case of deciding to form the group transport (YES in step S401), the instruction unit 403 instructs the plurality of transport devices to move to form the group (step S402).

The plurality of transport devices forms the group for performing the group transport, and performs an operation of transporting the transport object from the transport source to the transport destination.

The decision unit 402 can be implemented using the function of the decision unit 202 as described with reference to FIG. 1. The instruction unit 403 can be implemented using the function of the instruction unit 204 as described with reference to FIG. 1. Therefore, the transport control device 401 can be implemented using the function of the transport control device 401 as described with reference to FIG. 1.

Next, an effect regarding the transport control device 401 according to the second example embodiment of the present invention will be described.

According to the transport control device 401 according to the second example embodiment, high transport efficiency can be achieved. This is because the transport mode is determined according to the load of the transport processing, and the transport device is controlled according to the transport mode. The reason for this will be described in detail.

As described with reference to FIG. 14B or FIGS. 18A to 18D, the group transport can transport a larger transport object than individual transport. In addition, the distance between the plurality of transport objects in the transport processing is shorter in the group transport than in the individual transport. Further, the individual transport cannot carry a package at a speed higher than the moving speed of the transport control device itself, whereas in the group transport, it is not necessary to move the transport control device itself, and only to move the package, so that the transport speed per unit time of the transport unit is generally faster than that of the individual transport. Therefore, the group transport has higher transport performance than the individual transport.

In addition, the transport control device 401 determines the transport mode on the basis of the load of the transport processing. For example, the transport control device 401 assigns the group transport to transport processing with a high load, and assigns the individual transport to transport processing with a low load. In other words, the transport control device 401 determines the transport mode capable of efficiently transporting the transport object according to the load of the transport processing. Therefore, according to the transport control device 401, high transport efficiency can be achieved.

### Third Example Embodiment

Next, a third example embodiment of the present invention will be described.

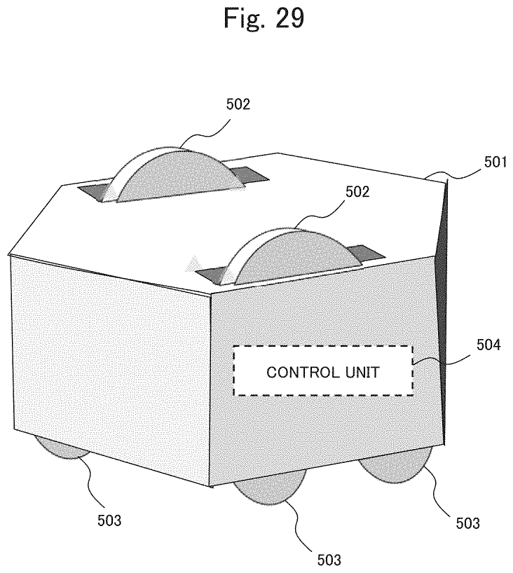

A configuration of a transport device 501 according to the third example embodiment of the present invention will be described in detail with reference to FIG. 29. FIG. 29 is a perspective view illustrating an example of a configuration of the transport device 501 according to the third example embodiment of the present invention.

The transport device 501 according to the third example embodiment includes a transport unit 502, a moving unit 503, and a control unit 504.

The moving unit 503 controls movement of the transport device 501. In other words, the moving unit 503 enables the transport device 501 to move. The moving unit 503 can be implemented using, for example, wheels, an endless track (for example, crawlers), an air cushion, a propeller, or the like.

The transport unit 502 transports a transport object. As described with reference to FIGS. 15A to 18D, for example, the transport unit 502 transports the transport object using a belt, a tire, a flapper, air injection, a wheel, a belt conveyor, a chain conveyor, a driving roller, or the like.

The control unit 504 receives an instruction from the outside, and controls the operation of the moving unit 503 and the operation of the transport unit 502 according to the received instruction. The instruction indicates implementation of group transport (see the description using FIG. 14B) in which a plurality of transport devices 501 transports the transport object in cooperation from a transport source to a transport destination, or implementation of individual transport in which the transport object is transported from the transport source to the transport destination.

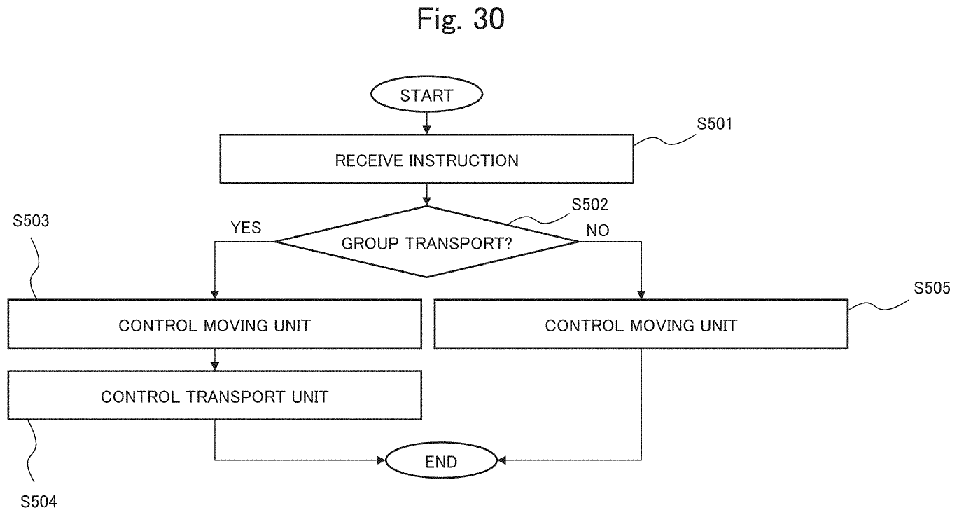

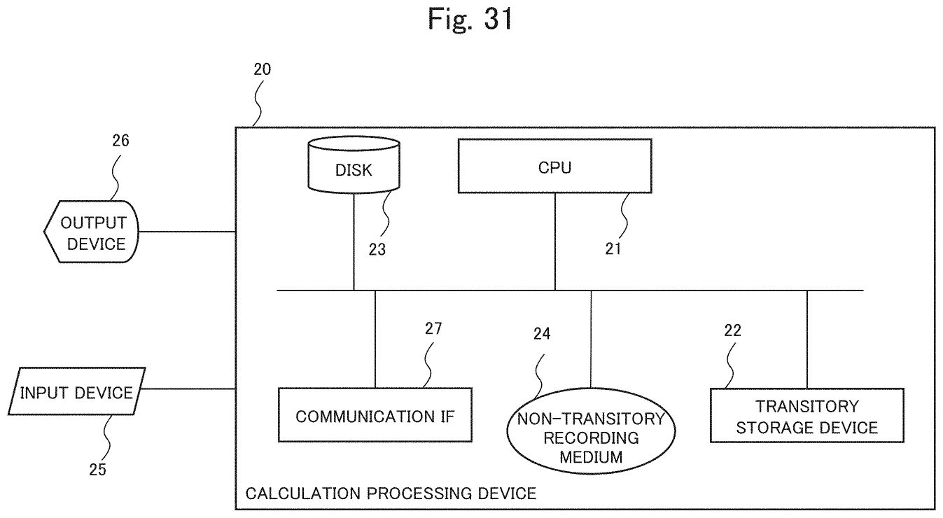

Next, an operation of the transport device 501 according to the third example embodiment of the present invention will be described in detail with reference to FIG. 30. FIG. 30 is a flowchart illustrating an example of a flow of an operation of the transport device 501 according to the third example embodiment.

The control unit 504 receives the instruction (step S501) and decides whether the instruction indicates the group transport or the individual transport (step S502).

In the case where the instruction indicates implementation of the group transport (YES in step S502), the control unit 504 controls the moving unit 503 to move to a position where a group for implementing the group transport is formed (step S503). The control unit 504 further controls the transport unit 502 to transport the transport object at the position (step S504).

In the case where the instruction indicates implementation of the individual transport (NO in step S502), the control unit 504 controls the moving unit 503 to transport the transport object from the transport source to the transport destination (step S505).

The moving unit 503 can be implemented using the function of the moving unit 303 as described with reference to FIG. 2. The transport unit 502 can be implemented using the function of the transport unit 302 as described with reference to FIG. 2. The control unit 504 can be implemented using the function of the control unit 304 as described with reference to FIG. 2, the function of the decision unit 202, the function of the determination unit 203, and the function of the instruction unit 204, as described with reference to FIG. 1. Therefore, the transport device 501 can be implemented using the function of the transport control device 201 as described above with reference to FIG. 1 and the function of the transport device 301 as described with reference to FIG. 2.

Next, an effect regarding the transport device 501 according to the third example embodiment of the present invention will be described.

According to the transport device 501 according to the third example embodiment, high transport efficiency can be achieved. This is because the transport device 501 changes the transport mode according to the instruction.

As described with reference to FIG. 14B or FIGS. 18A to 18D, the group transport can transport a larger transport object than individual transport. In addition, the distance between the plurality of transport objects in the transport processing is shorter in the group transport than in the individual transport. Therefore, the group transport has higher transport performance than the individual transport.

Further, the transport device 501 changes the transport mode according to the instruction. For example, the transport device 501 performs group transport for the transport processing with a high load, and performs the individual transport for transport processing with a low load. In other words, the transport device 501 changes the transport mode so as to efficiently transport the transport object according to the instruction. Therefore, according to the transport device 501, high transport efficiency can be achieved.

### Hardware Configuration Example

A configuration example of hardware resources for implementing the transport device or the transport control device according to one of the above-described example embodiments of the present invention, using a calculation processing device (information processing device or computer) will be described. Note that the transport device or the transport control device may be physically or functionally implemented using at least two calculation processing devices. However, the transport device or the transport control device may be implemented as a dedicated device.

FIG. 31 is a block diagram schematically illustrating a hardware configuration example of a calculation processing device capable of implementing the transport device or the transport control device according to one of the example embodiments of the present invention. A calculation processing device 20 includes a central processing unit (hereinafter referred to as “CPU”) 21, a transitory storage device 22, a disk 23, a non-transitory recording medium 24, and a communication interface (hereinafter referred as “communication IF”) 27. The calculation processing device 20 may be connectable to an input device 25 and an output device 26. The calculation processing device 20 can transmit and receive information to and from other calculation processing devices and communication devices via the communication IF 27.

The non-transitory recording medium 24 is a computer readable compact disc or digital versatile disc, for example. Further, the non-transitory recording medium 24 may be a universal serial bus memory (USB memory), a solid state drive, or the like. The non-transitory recording medium 24 can store the program without supplying power and enables carry. The non-transitory recording medium 24 is not limited to the above-described medium. Further, instead of the non-transitory recording medium 24, the program may be carried via the communication IF 27 and a communication network.

The transitory storage device 22 is computer readable and can store data temporarily. The transitory storage device 22 is a memory such as a dynamic random access memory (DRAM) or a static random access memory (SRAM).

That is, the CPU 21 copies a software program (computer program: hereinafter simply referred to as “program”) stored in the disk 23 to the transitory storage device 22 at the time of execution, and executes arithmetic processing. The CPU 21 reads data necessary for the program execution from the transitory storage device 22. In a case where display is necessary, the CPU 21 displays an output result on the output device 26. In a case where the program is input from the outside, the CPU 21 reads the program from the input device 25. The CPU 21 interprets and executes the control program (FIGS. 4 to 7, FIGS. 15A to 18D, FIG. 28, or FIG. 30) in the transitory storage device 22 associated with the function (processing) represented by each unit illustrated in FIG. 1, FIG. 2, FIG. 27, or FIG. 29 described above. The CPU 21 executes the processing described in the above-described each example embodiment of the present invention.

That is, in such a case, it can be understood that each example embodiment of the present invention can also be achieved by the control program. Furthermore, it can be understood that each example embodiment of the present invention can be achieved by a non-transitory recording medium readable by a computer in which the control program is recorded.

The present invention has been described with reference to the above-described example embodiments as exemplary examples. However, the present invention is not limited to the above-described example embodiments. That is, various aspects that will be understood by those of ordinary skill in the art can be applied without departing from the scope of the present invention as defined by the claims.

Some or all of the above example embodiments can be described as the following supplementary notes. However, the present invention exemplarily described by each of the above-described example embodiments is not limited to below.

(Supplementary Note 1)

A transport device including:

a transport unit that transports a transport object;

a moving unit that controls movement of the transport device; and

a control unit that controls an operation of the transport unit and the moving unit according to an instruction, in which,

in a case of forming a situation of the instruction instructing implementation of group transport in which a plurality of transport devices performs transport in cooperation from a transport source to a transport destination, the control unit controls the moving unit to move to a position where a group for implementing the group transport is formed, and controls the transport unit to transport the transport object at the position, and

in a case of the instruction instructing implementation of individual transport of conveying the transport object from the transport source to the transport destination, the control unit controls the moving unit to move from the transport source to the transport destination.

(Supplementary Note 2)

The transport device according to supplementary note 1, further including:

a detection unit that detects movement of the transport object, in which

the control unit controls the transport unit in accordance with information obtained by the detection unit.

(Supplementary Note 3)

The transport device according to supplementary note 1 or 2, further including:

a detection unit that detects surroundings of the transport device, in which

the control unit controls the moving unit in accordance with information obtained by the detection unit.

(Supplementary Note 4)

The transport device according to any one of supplementary notes 1 to 3, in which

the control unit controls the moving unit in such a way that a transportable direction of the transport unit goes along a transport path from the transport source to the transport destination in a case of the group transport.

(Supplementary Note 5)

The transport device according to any one of supplementary notes 1 to 3, further including:

a rotating unit that adjusts a transportable direction of the transport unit, in which

the control unit controls the rotating unit in such a way that the transportable direction of the transport unit goes along a transport path from the transport source to the transport destination in a case of the group transport.

(Supplementary Note 6)

The transport device according to any one of supplementary notes 1 to 5, further including:

a coupling unit that is coupled to another transport device or a fixed object, in which

the control unit controls the coupling unit to couple the transport device to the another transport device or the fixed object in a case of changing the individual transport to the group transport, and cancels the coupling to the another transport device or the fixed object in a case of changing the group transport to the individual transport.

(Supplementary Note 7)

The transport device according to supplementary note 4, in which

the control unit controls the moving unit in such a way that a mode of the transport path is maintained in a case of forming the transport path.

(Supplementary Note 8)

The transport device according to any one of supplementary notes 1 to 7, further including:

a support that release contact between the moving unit and an outside in the case of the group transport, in which

the transport unit and the moving unit share a rotation mechanism.

(Supplementary Note 9)

The transport device according to supplementary note 8, further including:

a coupling unit that is coupled to another transport device or a fixed object, in which

the control unit controls the coupling unit to be coupled to the another transport device or the fixed object and controls the support to release the contact in a case of performing the group transport.

(Supplementary Note 10)

The transport device according to any one of supplementary notes 1 to 9, further including:

an elastic body on a side surface, in which

the control unit controls the moving unit to fill a gap between another transport device and the transport device performing the group transport with the elastic body in a case of performing the group transport.

(Supplementary Note 11)

The transport device according to supplementary note 10, in which

the elastic body is at least one of a sponge, a brush, a soft resin, a bubble buffering agent, or a spring.

(Supplementary Note 12)

The transport device according to any one of supplementary notes 1 to 11, in which

a shape formed by a side surface of the transport device is a circle, an ellipse, or a polygon.

(Supplementary Note 13)

A transport method including:

by a transport device including a transport unit that transports a transport object and a moving unit that controls movement of the transport device, and the transport device that controls an operation of the transport unit and the moving unit according to an instruction,

in a case that the instruction includes forming a situation of implementation of group transport in which a plurality of the transport devices performs transport in cooperation from a transport source to a transport destination, controlling the moving unit to move to a position where a group for implementing the group transport is formed, and controlling the transport unit to transport the transport object at the position; and

in a case that the instruction includes implementing individual transport of conveying the transport object from the transport source to the transport destination, controlling the moving unit to move from the transport source to the transport destination.

(Supplementary Note 14)

A non-transitory computer-readable recording medium embodying a control program, the control program causing a transport device including a transport unit that transports a transport object and a moving unit that controls movement of the transport device, the transport device that controls the transport unit and the moving unit according to an instruction, to perform a method, the method including:

in a case of forming a situation of the instruction instructing implementation of group transport in which a plurality of the transport devices performs transport in cooperation from a transport source to a transport destination, controlling the moving unit to move to a position where a group for implementing the group transport is formed, and controlling the transport unit to transport the transport object at the position; and

in a case of the instruction instructing implementation of individual transport of conveying the transport object from the transport source to the transport destination, controlling the moving unit to move from the transport source to the transport destination.

### REFERENCE SIGNS LIST

101 Target system
151 Communication network
152 Request information storage unit
153 Movement information storage unit
154 Layout information storage unit
155 Transport path information storage unit
156 Detection device
201 Transport control device
202 Decision unit
203 Determination unit
204 Instruction unit
301 Transport device
302 Transport unit
303 Moving unit
304 Control unit
305 Detection unit
306 Rotating unit
401 Transport control device
402 Decision unit
403 Instruction unit
501 Transport device
502 Transport unit
503 Moving unit
504 Control unit
20 Calculation processing device
21 CPU
22 Volatile storage device
23 Disk
24 Non-transitory recording medium
25 Input device
26 Output device
27 Communication IF

What is claimed is:

1. A transport device comprising:
a transport unit that transports a transport object;
a moving unit that controls movement of the transport device; and
a control unit that controls an operation of the transport unit and the moving unit according to an instruction, wherein,
in a case that the instruction includes forming a situation of implementation of group transport in which a plurality of transport devices performs transport in cooperation from a transport source to a transport destination, the control unit controls the moving unit to move to a position where a group for implementing the group transport is formed, and controls the transport unit to transport the transport object at the position, and
in a case that the instruction includes implementing individual transport of conveying the transport object from the transport source to the transport destination, the control unit controls the moving unit to move from the transport source to the transport destination.

2. The transport device according to claim 1, further comprising:
a detection unit that detects movement of the transport object, wherein
the control unit controls the transport unit in accordance with information obtained by the detection unit.

3. The transport device claim 1, further comprising:
a detection unit that detects surroundings of the transport device, wherein
the control unit controls the moving unit in accordance with information obtained by the detection unit.

4. The transport device according to claim 1, wherein
the control unit controls the moving unit in such a way that a transportable direction of the transport unit goes along a transport path from the transport source to the transport destination in a case of the group transport.

5. The transport device according to claim 1, further comprising:
a rotating unit that adjusts a transportable direction of the transport unit, wherein
the control unit controls the rotating unit in such a way that the transportable direction of the transport unit goes along a transport path from the transport source to the transport destination in a case of the group transport.

6. The transport device according to claim 1, further comprising:
a coupling unit that is coupled to another transport device or a fixed object, wherein
the control unit controls the coupling unit to couple the transport device to the another transport device or the fixed object in a case of changing the individual transport to the group transport, and cancels the coupling to the another transport device or the fixed object in a case of changing the group transport to the individual transport.

7. The transport device according to claim 4, wherein
the control unit controls the moving unit in such a way that a mode of the transport path is maintained in a case of forming the transport path.

8. The transport device according to claim 1, further comprising:
a support that release contact between the moving unit and an outside in the case of the group transport, wherein
the transport unit and the moving unit share a rotation mechanism.

9. The transport device according to claim 8, further comprising:
a coupling unit that is coupled to another transport device or a fixed object, wherein
the control unit controls the coupling unit to be coupled to the another transport device or the fixed object and controls the support to release the contact in a case of performing the group transport.

10. The transport device according to claim 1, further comprising:
an elastic body on a side surface, wherein
the control unit controls the moving unit to fill a gap between another transport device and the transport device performing the group transport with the elastic body in a case of performing the group transport.

11. The transport device according to claim 10, wherein
the elastic body is at least one of a sponge, a brush, a soft resin, a bubble buffering agent, or a spring.

12. The transport device according to claim 1, wherein
a shape formed by a side surface of the transport device is a circle, an ellipse, or a polygon.

13. A transport method comprising:
by a transport device including a transport unit that transports a transport object and a moving unit that controls movement of the transport device, and the transport device that controls an operation of the transport unit and the moving unit according to an instruction,
in a case that the instruction includes forming a situation of implementation of group transport in which a plurality of the transport devices performs transport in cooperation from a transport source to a transport destination, controlling the moving unit to move to a position where a group for implementing the group transport is formed, and controlling the transport unit to transport the transport object at the position; and
in a case that the instruction includes implementing individual transport of conveying the transport object from the transport source to the transport destination, controlling the moving unit to move from the transport source to the transport destination.

14. A non-transitory computer-readable recording medium embodying a control program, the control program causing a transport device including a transport unit that transports a transport object and a moving unit that controls movement of the transport device, the transport device that controls an operation of the transport unit and the moving unit according to an instruction, to perform a method, the method comprising:
in a case that the instruction includes forming a situation of implementation of group transport in which a plurality of the transport devices performs transport in cooperation from a transport source to a transport destination, controlling the moving unit to move to a position where a group for implementing the group transport is formed, and controlling the transport unit to transport the transport object at the position; and
in a case that the instruction includes implementing individual transport of conveying the transport object from the transport source to the transport destination, controlling the moving unit to move from the transport source to the transport destination.
